(19) United States
(12) Patent Application Publication
(10) Pub. No.: US 2024/0023500 A1
(43) Pub. Date: Jan. 25, 2024

(54) A SYSTEM FOR INDOOR CULTIVATION OF PLANTS WITH SIMULATED NATURAL LIGHTING CONDITIONS

(71) Applicant: GROWIN LTD., RA'ANANA (IL)

(72) Inventor: Menachem KOP, Ra'ananna (IL)

(21) Appl. No.: 18/307,980

(22) Filed: Apr. 27, 2023

Related U.S. Application Data
(63) Continuation-in-part of application No. 15/557,194, filed on Sep. 11, 2017, now abandoned.
(60) Provisional application No. 62/135,514, filed on Mar. 19, 2015.

(51) Int. Cl. A01G 31/02; F21V 21/104; F21V 29/56; A01G 27/00

(52) U.S. Cl. CPC A01G 31/02; F21V 21/104; F21V 29/56; A01G 27/003; A01G 2031/006

(57) ABSTRACT

An indoor soilless plant cultivating system. The system has a plurality of (a) stationary light posts, (b) plant growth towers, and (c) irrigation means. Each post is adapted to illuminate a predetermined sector of an indoor facility in accordance with a predetermined illumination signature. Each tower is rotatable about a substantially vertical axis in accordance with a predetermined timing sequence so as to be exposable to the light generated at any given time by one or more of the light posts and that are arranged by at least one module defining a module darkened interior region within which plants being instantaneously positioned receive a sensation of nighttime. The irrigation means supplies the plants being cultivated in each of said towers with a nutrient-rich solution.

This application is a continuation-in-part application of U.S. patent application Ser. No. 15/557,194, which is a national phase application of international patent application no. IL2016/050300 filed on Mar. 18, 2016, which claims priority from U.S. patent application No. 62/135,514 filed on Mar. 19, 2015.

### FIELD OF THE INVENTION

The present invention relates to the field of a plant cultivating system. More particularly, the invention relates to an indoor soilless plant cultivation system, for cultivating plants in a nutrient-rich solution.

### BACKGROUND OF THE INVENTION

Many people are attracted to living in urban settings by virtue of the economic progress that may be realized. Cities bring together diverse groups of people and companies in ways that increase productivity and create the networks, clusters, and chance interactions that lead to the discovery of new innovations and the creations of new entrepreneurial businesses. Other advantages of living in urban settings include the large number of cultural activities that are available and the relative ease in commuting to work.

While 60% of the human population now lives in cities and are protected against the outdoor elements, food-bearing plants are subjected to the rigors of the outdoors. People hope for a good weather year in order to ensure that the food supply will be readily available. Many times due to a rapidly changing climate regime, however, massive floods, protracted droughts, class 4-5 hurricanes, and severe monsoons take their toll each year, destroying millions of tons of valuable crops.

By the year 2050, nearly 80% of the earth's population will reside in urban centers. Applying the most conservative estimates to current demographic trends, the Earth's population will increase by about 3 billion people during this period. An estimated 10.9 million square km of new land (about 20% more land than all of Brazil) will be needed to grow enough food to feed them, if traditional farming practices continue as today. At present, throughout the world, over 80% of the land that is suitable for raising crops is in use. Historically, some 15% of that agriculturally suitable land has been laid waste by poor management practices. Indeed, much land has become despoiled, such that natural eco-zones have been converted into semi-arid deserts.

The traditional agricultural practice of growing food-bearing plants outdoors, or within greenhouses located at agricultural areas, is problematic in terms of weather related or pest related crop failure, the cost of transporting the grown crops to food distribution centers, the ecological damage due to fossil fuel emissions from the vehicles that transport the crops and that are used for performing agricultural activities such as plowing, the cost for fertilizers and pesticides, the occurrence of infectious diseases acquired at an agricultural interface, and ecological damage due to agricultural runoff.

In order to sustain the Earth's growing population, it would be desirable to learn how to safely grow food within city-located, environmentally controlled multistory facilities, in order to maintain a readily available food supply while overcoming the problems associated with traditional agricultural practices.

Some indoor hydroponic system are known from the prior art wherein plant growth units are stacked one on top of another, a solution of water and plant nutrient is introduced to the plants, and panels comprising artificial light sources that eliminate the need for natural sunlight and enable light cycles of varied duration are provided on top of each plant growth unit.

Photoperiodic flowering plants flower in response to a sensed change in night length, and therefore require a continuous period of darkness before floral development can begin. However, the prior art light panels for simulating such light cycles are costly due to the need of a light panel at each level of a growth unit and of a dedicated control system for each panel. Additionally, the light panels are self-heating, and expensive to operate cooling systems are needed to remove the generated heat.

Light-emitting diodes (LEDs) have been found to be ideal light sources for crop production by virtue of their small size, durability, long operating lifetime, wavelength specificity, relatively cool emitting surfaces and linear photon output with electrical input current. Work at NASA's Kennedy Space Center has focused on the proportion of blue light required for normal plant growth as well as the optimum wavelength of red and the red/far-red ratio. The addition of green wavelengths for improved plant growth has also been addressed. [“Plant Productivity in Response to LED Lighting”, G. Massa et al, HortScience, December 2008, vol. 43, no. 7, 1951-1956]

However, the inability of such prior art lighting systems to provide substantially equal light distribution limits implementation thereof for an indoor plant growth unit of large vertical dimensions.

Another drawback of prior art systems for cultivating plants is the safety of workers, when pest control is needed, in which case the entire cultivating space is sprayed by pesticide. This implies using a greater amount of pesticide. However, some pesticides may cause cancer and other health problems, as well as harming the environment.

It is an object of the present invention to provide an indoor soilless cultivating system for the sustainable crop production of a safe and varied food supply.

It is an additional object of the present invention to provide an indoor soilless cultivating system with a lighting system that maintains a substantially equal light distribution to facilitate photosynthesis at an indoor plant growth unit of relatively large vertical dimensions.

It is an additional object of the present invention to provide an indoor soilless cultivating system by which the operating and capital costs of light sources used to simulate the light cycles required by photoperiodic flowering plants are significantly reduced relative to those of the prior art.

It is yet an additional object of the present invention to provide an indoor soilless cultivating system by which the operating and capital costs of cooling systems for removing the heat generated by light sources that simulate the cyclical nature of natural sunlight are significantly reduced relative to those of the prior art.

It is yet another object of the present invention to provide an indoor soilless cultivating system which saves a substantial amount of the required pesticide to be sprayed, to thereby reduce the exposure of workers and the environment to harmful effects.

Other objects and advantages of the invention will become apparent as the description proceeds.

### SUMMARY OF THE INVENTION

The present invention provides an indoor soilless plant cultivating system, comprising a plurality of stationary light posts, each of which adapted to illuminate a predetermined sector of an indoor facility in accordance with a predetermined illumination signature; a plurality of plant growth towers that are rotatable about a substantially vertical axis in accordance with a predetermined timing sequence so as to be exposable to the light generated at any given time by one or more of the light posts and that are arranged by at least one module defining a module darkened interior region within which plants being instantaneously positioned receive a sensation of nighttime; and irrigation means for supplying the plants being cultivated in each of said towers with a nutrient-rich solution.

The system further comprises a drive unit for cyclically rotating each of the towers so as to be sequentially exposed to morning light conditions, noon light conditions, afternoon light conditions and nighttime conditions in accordance with the illumination signature emitted by the light posts of the at least one module. The drive unit may be configured to cause a complete tower rotation once every 24-hour period.

Each of the towers is preferably configured with a plurality of mounting elements by each of which a corresponding plant is mountable at a different tower peripheral portion and is urged to grow outwardly from said peripheral portion, groups of said mounting elements being defined at different height levels of the tower.

Leaves of all of the plants being grown on one of the towers are exposed to a substantially uniform distribution of light emitted from light elements mounted on an adjacent one of the light posts for a given emulated time period despite a height differential between the plants.

To achieve the substantially uniform distribution of light, the light elements may be sufficiently small such that they have a density of no less than 40 light elements within a light post height of 50 cm and are mounted on each of the light posts in such a way that only one light element is mounted at any given height. A segment of the light elements has a predetermined number and sequence of light elements arranged such that constituent beams emitted from the light elements of said segment are mixed within a conical distribution angle to provide a photosynthetic photon flux density at the tower peripheral portion upon which the mixed beam impinges that stimulates photosynthesis for a given plant being grown. Thus the photosynthetic photon flux density at another tower peripheral portion being illuminated at the given emulated time period is substantially equal.

The predetermined number and sequence of light elements are preferably repeated along the height of the light post for all other segments.

In one aspect, each of the light elements is provided with a directional lens configured to produce a light emitting angle whose angular boundaries are incident on the tower periphery, causing propagation of the emitted light to an internal region of the module between two adjacent towers to be blocked as a result of its incidence on the tower periphery, to thereby ensure that said internal region will be darkened to a radiation level less than a predetermined photosynthetically active radiation level for the plant being cultivated.

The plant cultivating system provides at least the following advantages:
A modular scalable system that is simple to ship, build and maintain.
The system can be deployed in any existing building with any geometrical shape regardless of its original purpose.
Dynamic allocation of the number of towers inside the same facility, or on different floors of the same facility, for different crops depending on seasonal demand or opportunities.
The facility is isolated from outdoor conditions to support plant cultivation every hour and every day of the year regardless of the outdoor weather conditions and climate.
Substantial shortening of the growth cycle of each plant, for extremely fast growth of high quality products.
The number of plants able to be grown in the system for a given area is 7 times greater as compared to traditional hydroponic growth.
Operation of the system approaches an optimum point in combining usage of light, air, water which are the most critical elements conducive to plant growth.
The plants being grown are not subject to damage due to extreme meteorological conditions and natural disasters.
Crops have maximum nutritional values, superior taste and freshness.
Reduced refrigerated transportation time and cost.
As the cultivating system is soilless, 95% less water is required to grow the crops than prior art systems.
No greenhouse gas emissions.
Easy and relatively inexpensive closed perimeter security and surveillance systems, preventing agricultural theft losses that are on the rise worldwide.
No soil pollutants.
Solution of land shortage problem.
Airflow system by which plant-released carbon dioxide is transported to a daytime region for an improved photosynthesis process.
Artificial pollination.

The present invention is also directed to an indoor plant cultivating system, comprising a plant growth apparatus on which one or more plants are mountable;
a stationary light post adapted to illuminate said one or more plants in accordance with a predetermined illumination signature; and irrigation means for supplying said one or more plants with a nutrient-rich solution, wherein each of one or more segments of light elements mounted on said light post has a predetermined number and sequence of light elements arranged such that constituent beams emitted from the light elements of said segment are mixed within a conical distribution angle to provide a photosynthetic photon flux density at a peripheral portion of said plant growth apparatus upon which the mixed beam impinges that stimulates photosynthesis for said one or more plants being grown.

The present invention is also directed to an artificial pollination system, comprising a post on which are mounted an air discharge nozzle; a plant growth apparatus on which one or more pollen bearing plants are mountable; a sensor for detecting an instantaneous position of said one or more plants; an air receiver tank for storage of compressed air; a conduit extending from said air tank and in fluid communication with said nozzle; a control valve operatively connected with said conduit; and a controller in data communication with said sensor and said control valve, wherein said controller is operable to command opening of said control valve for a predetermined time, when a signal transmitted by said sensor is indicative that at least one of said plants is in pollen releasable proximity to said nozzle, so that a pulsed supply of the compressed air at a sufficiently high pressure to induce release of pollen from its anther and airborne transport of said released pollen to a carpel of the same or of an adjacent plant will be directed to said plant in pollen releasable proximity to said nozzle.

The present invention is also directed to an adaptive apparatus for use in conjunction with an indoor soilless plant cultivating system, comprising a plant growth tower configured with a drive unit that is rotatable about a substantially vertical axis by a complete tower rotation once every 24-hour period; a plurality of stationary and circumferentially spaced light posts on each of which are mounted a plurality of vertically spaced light elements, light emitted by said plurality of light posts impinging on a periphery of said tower to define an illuminated peripheral region that is illuminated in accordance with a predetermined plant-specific illumination signature and a non-illuminated region associated with said tower periphery that is unimpinged by said emitted light; one or more stationary guiding rods connected to a housing element of said tower, to which said plurality of light posts are mounted and by which a circumferential spacing between two of said light posts is adjustable; and irrigation means for supplying the plants being cultivated in said tower with a nutrient-rich solution, wherein said tower is rotatable about the substantially vertical axis so as to be sequentially exposed to morning light conditions, noon light conditions, afternoon light conditions and nighttime conditions.

### BRIEF DESCRIPTION OF THE DRAWINGS

In the drawings:

FIG. 1 is a plan view of a plant cultivating system, according to one embodiment of the present invention;

FIG. 2 is a plan view of a plant cultivating system, according to another embodiment of the invention;

FIGS. 3A and 3B are a schematic side view of two light posts, respectively, showing the relative arrangement of the light elements mounted thereon;

FIG. 3C is a schematic illustration of the conical distribution angle of light that is emitted from a light element segment of a light post and that impinges upon a peripheral tower portion;

FIG. 4 is a schematic illustration in elevation view of one embodiment of irrigation means for irrigating plants being hydroponically cultivated;

FIG. 5 is a schematic illustration in elevation view of one embodiment of irrigation means for irrigating plants being aeroponically cultivated;

FIGS. 6A and 6B are schematic illustrations in elevation view of another embodiment of irrigation means for irrigating plants being aeroponically cultivated;

FIG. 7 is a front view from within the interior of a portion of an outer wall of a tower used in conjunction with the irrigation means of FIG. 1;

FIG. 8 is a schematic illustration of a recycling system for efficiently utilizing the irrigation fluid used in conjunction with the plant cultivating system;

FIG. 9 is a schematic illustration in side view of a temperature of a closed-loop liquid circulation system air to control the temperature of air in the vicinity of a tower;

FIG. 10 is a schematic illustration of an air circulation arrangement used in conjunction with the plant cultivating system for facilitating an increase in plant growth;

FIG. 11 is a schematic illustration of an artificial pollination system used in conjunction with the plant cultivating system;

FIG. 12 is a perspective view from the side of structural elements for use in conjunction with a module of towers;

FIG. 13 is a perspective view from the top of the structural elements of FIG. 12, showing an upper frame and a centrally positioned ceiling fan;

FIG. 14 is an enlarged perspective view from the side of the upper frame of FIG. 13, showing one embodiment of a drive unit for rotating a tower;

FIG. 15 is an enlarged perspective view from the side of a tower wall of FIG. 13, showing a removable plant supporter;

FIG. 16 is a perspective view of a multidirectional spraying column;

FIG. 17 is a plan view of a module of towers, showing the relative position of the multidirectional spraying column of FIG. 16;

FIG. 18 is a schematic illustration of a control system used in conjunction with the plant cultivating system for modulating the light energy directed to the plants;

FIG. 19 is a schematic plan view of another embodiment of a module of towers;

FIG. 20 is a perspective view of one of the towers of the module of FIG. 19 and of two light post mounted guide rods to which it is connected;

FIG. 21 is an enlarged side view of a portion of the tower of FIG. 20, showing in perspective view two plant-received receptacles rendered transparent that are engaged with the tower;

FIG. 22 is a side view of one of the receptacles of FIG. 21 when separated from the tower;

FIG. 23 is a cross sectional view of one of the receptacles of FIG. 21 when engaged with the tower;

FIG. 24 is a method for developing a bud aeroponically or hydroponically;

FIG. 25 is a cross sectional view of a sponge that is usable in conjunction with the receptacle of FIG. 22; and

FIG. 26 is a schematic illustration of an embodiment of an airflow system.

### DETAILED DESCRIPTION OF THE INVENTION

The present invention is an energy efficient, indoor soilless plant cultivating system which employs a plurality of stationary light posts, each of which illuminates a predetermined sector of an indoor facility in accordance with a predetermined illumination signature. The plants to be cultivated are mounted on a plant growth unit provided with irrigation means (hereinafter “tower”) of a large vertical dimension similar to that of each light post, for efficiently utilizing the inner dimensions of the facility, which may be an abandoned building in an urban setting or a building in an industrial park dedicated to be used by the cultivating system. The system operates in conjunction with a module that includes a predetermined number of towers, such that each tower of a module is rotated by a drive unit about a vertical axis in accordance with a predetermined timing sequence so as to be exposable to the light generated at any given time by one or more of the light posts. An interior region of the module is not exposed to the light generated by any of the module related light posts, and the plants instantaneously positioned within the darkened interior region receive the sensation of nighttime.

The indoor facility is preferably isolated from the outdoor conditions, including light, humidity and temperature conditions, present outwardly from the facility. The plant cultivating system is able to emulate optimal outdoor growing conditions that are different from the instantaneous outdoor conditions, so that the leaves of all plants subjected to a controlled environment will be exposed to a substantially uniform light distribution for the given emulated time period despite a height differential between therebetween. Even though the plants are isolated from the outdoors, the production of fruit and seed crops is made possible by virtue of an artificial pollination system.

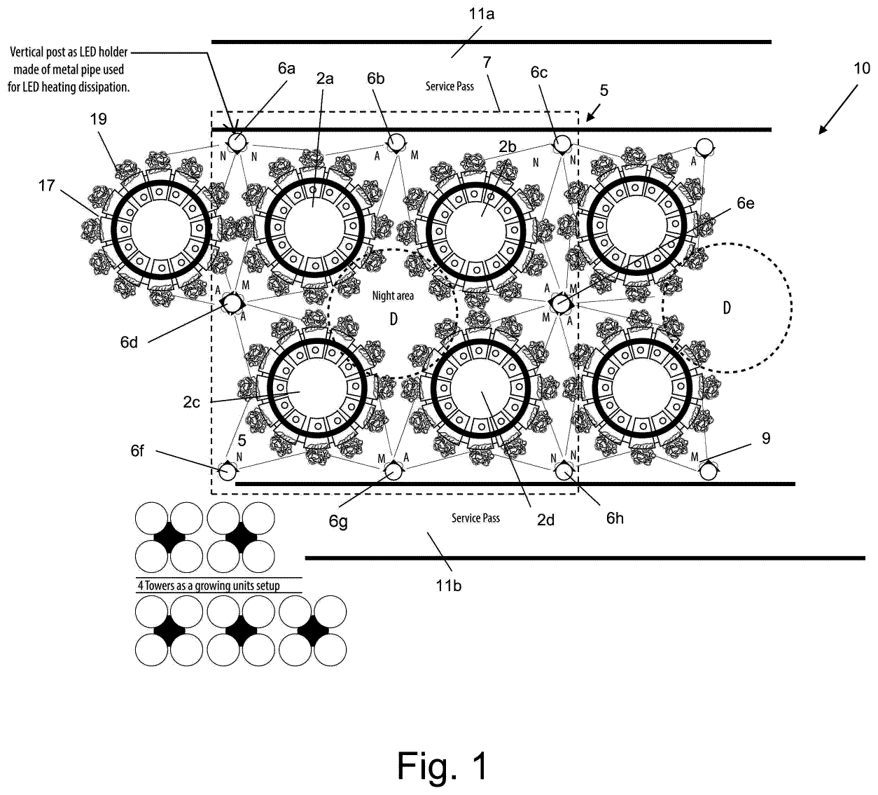

FIG. 1 schematically illustrates a plant cultivating system 10 in plan view, according to one embodiment of the present invention. Plant cultivating system 10 comprises a plurality of modules, and for purposes of brevity, one of the modules 5 will be described.

Module 5 includes four circular towers 2a-d arranged in a symmetrical square-like configuration. Eight evenly spaced light posts 6a-h are deployed adjacent to the imaginary perimeter 7 of module 5, such that first row light posts 6a-c are positioned adjacent to adjoining service pass 11a, third row light posts 6f-h are positioned adjacent to adjoining service pass 11b which is opposite to service pass 11a, and second row light posts 6d-e are positioned at the two sides, respectively, of perimeter 7 according to the illustrated orientation, while being positioned at an intermediate region of module 5 and interposed between a first row and third row light post.

Service passes 11a and 11b, to be used for accessing the towers for maintenance, plant treatment and harvesting purposes, may have a width of 70 cm. Harvesting may be carried out with manual carts that are advanceable along rails. The carts may have a hydrologic raising capability to permit comfortable access to an upper tower region. For use during extreme cold weather conditions, a rail may be configured as a series of interconnected round hollow pipes through which warm water is flowable, to support heat dispersion as a part of the ambient control system of the facility. These pipes may have a unique mechanical profile, for example funnel-shaped, to assist in uniformly spreading the heat.

The light element of each of the light posts may operate continually, to emit light with a same constant light intensity throughout a morning period, a noon period, an afternoon period and a nighttime period, in accordance with a predetermined post-specific illumination signature, along a predetermined angular sector S, e.g. 60 degrees. A number and sequence of the light elements are selected to generate a plant-specific and sector-specific signature defining the predetermined illumination signature.

The setting of the predetermined angular sector may be obtained by means of a directional lens 9 provided with each light element mounted on a post and by a selected spacing between a light element and a corresponding lens. Directional lens 9 is preferably a diverging lens that produces a predetermined diverging light emitting angle with respect to a vertical and horizontal plane. Each light element also has a designed illumination range.

The position of each of light posts 6a-h is carefully selected so that, together with the predetermined diverging light emitting angle of the lenses and the illumination range of the light elements, the emitted light will be incident on the periphery of one or two towers. Consequently, the propagation of emitted light becomes blocked as a result of its incidence on the tower periphery or on a vessel mounted on the tower periphery within which a plant is being grown. A boundary of a darkened region D interposed between the two second row light posts 6d and 6e is traced by a plurality of points of incidence, at least one point of incidence being localized at the periphery of each tower 2a-d of module 5 by the light emitted by one of light posts 6a-h associated with module 5. The blockage of the emitted light ensures that darkened region D will be darkened to a radiation level less than a predetermined photosynthetically active radiation level for the plant being cultivated.

In the exemplary deployment of the light posts, the illumination signature of posts 6a, 6c, 6f and 6h simulates the lighting conditions of noontime at a region N. The instantaneous illumination signature of posts 6b, 6d, 6e and 6g simulates the lighting conditions of morning at a region M, and afternoon or evening at a region A, with respect to light intensity and/or wavelength. Darkened interior region D is located beyond the limited illumination range of the lighting elements mounted on each of light posts 6a-h, and therefore plants instantaneously positioned within darkened region D receive the sensation of nighttime. A distance between the towers at a darkened region D may be 80 cm for towers having a diameter of 60 cm.

Each of towers 2a-d has mounting means 17 by which each corresponding plant 19 is retained on the periphery of a tower while being exposed to the light posts. The various plants are arranged in layers, so that plants 19 are found throughout the height and circumference of a tower, for maximum utilization of the volume within the facility. Plants 19 may also be arranged in an inclined disposition, so that will be urged to grow outwardly from the tower without interfering with an adjacent plant.

The plant cultivating system of the present invention is conducive to the growth of many different types of crops, particularly high quality crops that are not necessarily indigenous to the surroundings of the given facility by virtue of the optimal environment in which they are grown, including leafy vegetables such as lettuce, chicory, tomato, cucumber, chili, pepper and spinach, berries such as strawberries, cranberries, blueberries and raspberries, and herbs such as herbs for flavoring, food, medicine and cosmetics, for example medical cannabis.

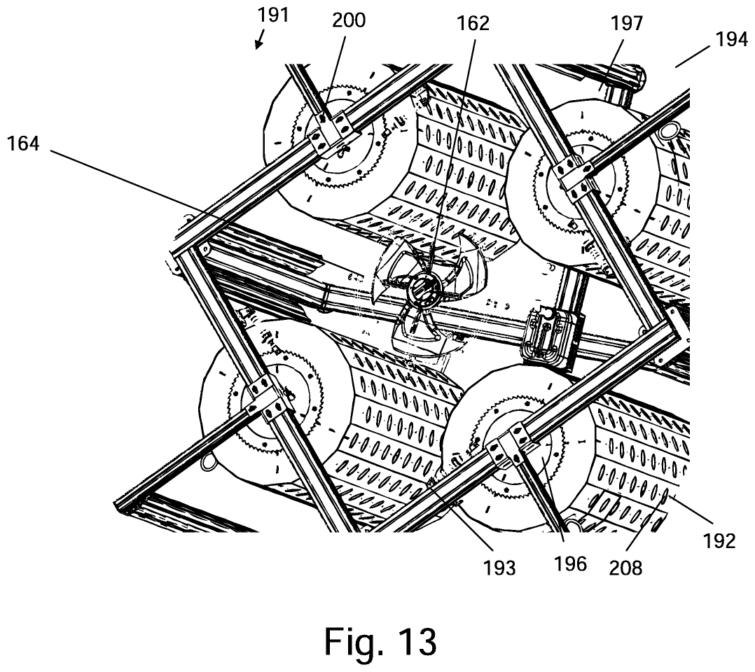

The circular configuration of the towers promotes trellising of climbing plants such as cherry tomatoes and grave vines around the tower periphery to advantageously minimize usage of the module surface area. Removable supporters 211 (FIG. 15) may be plugged into vacant holes 208 around the tower periphery to support the weight of the crop if the load on the tower is anticipated to be excessive.

Directional lens 9 may be configured to produce a light emitting angle whose angular boundaries, when taking into account the given tower diameter and the given distance from a light post to a tower, are tangential with, or are otherwise incident on, the periphery of the tower. The propagation of the emitted light to an internal region of module 5 is blocked as a result of its incidence on the tower periphery, to thereby ensure that the internal region between two adjacent towers will be darkened to a radiation level less than a predetermined photosynthetically active radiation level for the plant being cultivated, for example darkness levels of up to 90% or more. The darkness level is also assisted by the ongoing growth of the leaves or branches of the plants which help to block the penetration of light into the inner region.

The rotation of each of towers 2a-d by means of a central vertical shaft and a drive unit allows each plant 19 to be cyclically exposed to morning light conditions, noon light conditions, afternoon light conditions and nighttime conditions by completing a full rotation about its vertical axis once every 24-hour period, thus simulating a daily day/night cycle. The drive unit may be an electric motor, or a hydraulically or pneumatically actuated drive unit.

It will be appreciated that a tower need not rotate at a constant rate. If a selected plant flourishes when exposed to certain light conditions, the relative dwelling time of the plant in those optimum lighting conditions may be increased.

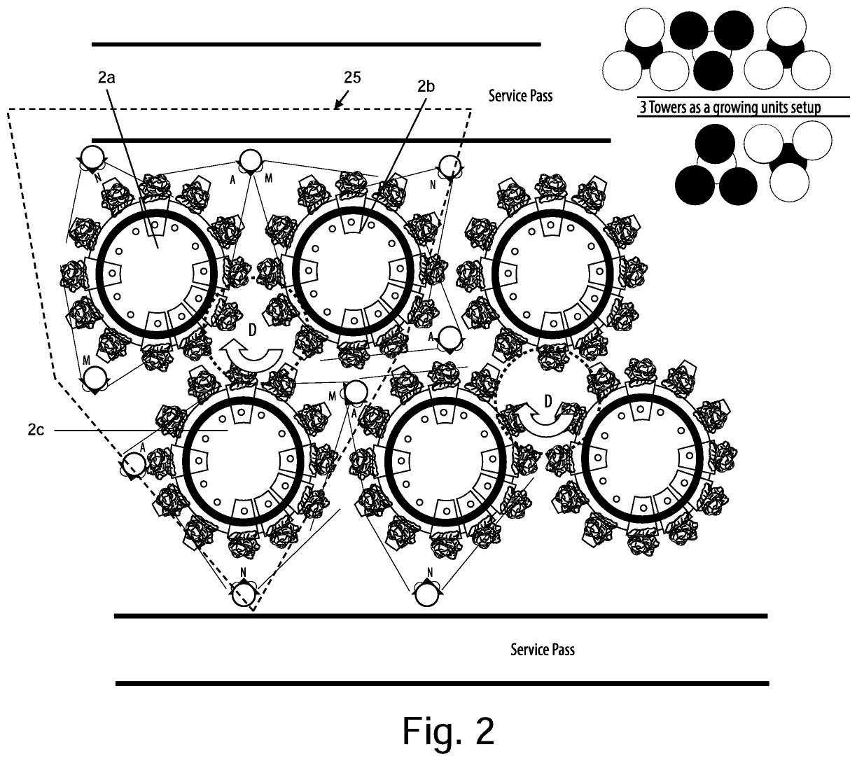

FIG. 2 illustrates a module 25 comprising three rotatable towers 2a-c, providing darkened interior region D, to which the mounted plants are cyclically exposed, as described above.

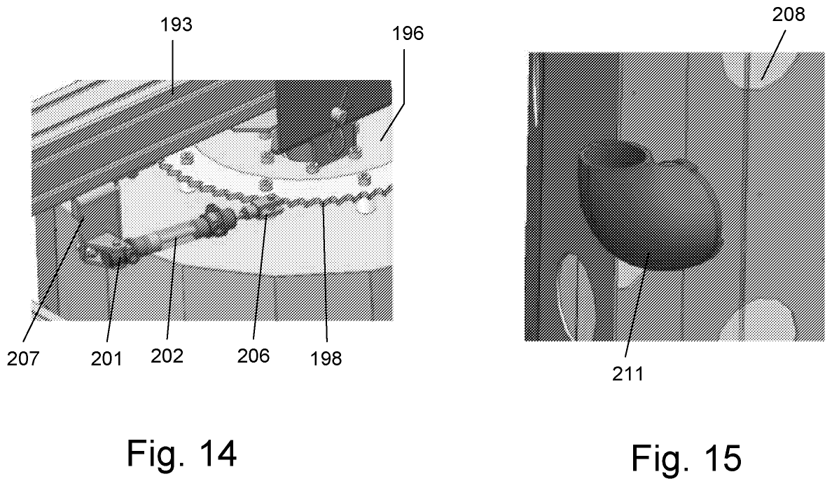

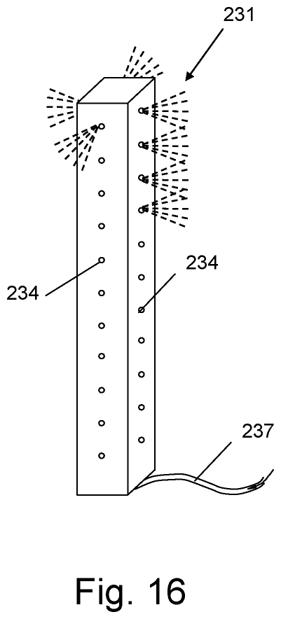

The definition of the darkened interior regions by the aforementioned module configurations advantageously contributes to the safety of workers and other bystanders by deploying a multidirectional spraying column 231 illustrated in FIGS. 16 and 17 within a darkened region D.

Multidirectional spraying column 231, which may have a rectilinear or curvilinear configuration, has a plurality of nozzles 234 that protrude in different directions. When pesticide is delivered through conduit 237, for example in response to a controlled duty cycle via an underground conduit, to spraying column 231, a spray is issued from each nozzle 234 and is directed at each of towers 2a-d. The extending direction and the spray pattern of each nozzle 234 are carefully selected to avoid pesticide wastage as a result of unnecessary spraying in a region R between towers.

Since towers 2a-d are continuously rotated, all plants will be exposed to the sprayed pesticide. However, workers are generally located within service passes 11a-b (FIG. 1) which are outwardly separated from the modules, and will therefore not be exposed to the sprayed pesticide. This spraying arrangement will increase the safety of workers and will significantly reduce, or substantially eliminate harm, to the environment by minimizing discharge of harmful pesticide. Also, the amount of pesticide needed for effective pest control will be significantly reduced.

Even though the plants are grown in a soilless environment and are therefore not susceptible to damage by soil dwelling pests, nevertheless Small plantings that were germinated outside the facility and were already infected by pests or bacteria before being mounted in a tower, and therefore need to be treated with pesticide.

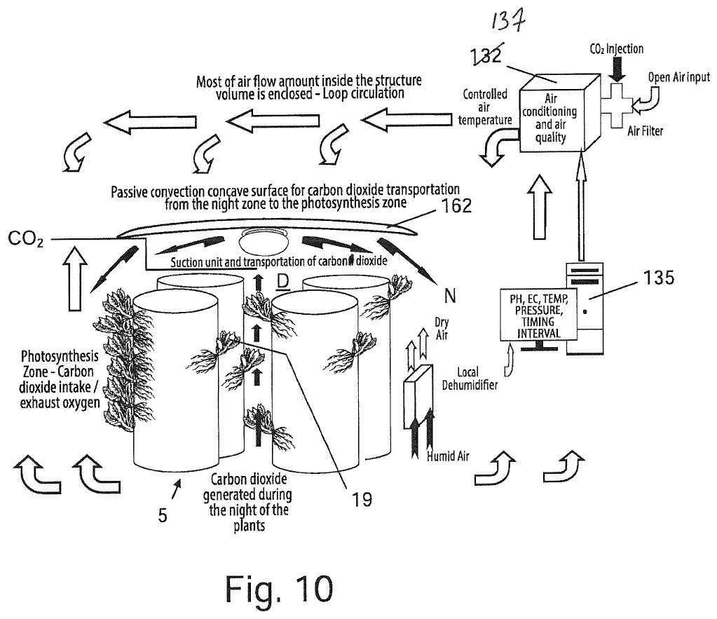

FIGS. 12-15 illustrate exemplary structural features for use with the plant cultivating system.

As shown in FIG. 12, the vertical shaft of each of the four towers 2a-d of module 5 is rotatably mounted from above in a corresponding seat or bearing provided in an upper square or rectangular frame 191 and from below in a corresponding seat or bearing provided in a bottom bar 197. Upper frame 191 may be embedded in a roof or ceiling portion 189, or may be internally open and positioned below roof or ceiling portion 189.

The eight stationary light posts 6a-h are attached to upper frame 191 and are in fixed contact with the underlying ground surface, light posts 6a, 6c, 6f and 6h extending downwardly from a corresponding corner of the upper frame and the remaining light posts being connected to a corresponding cross member 194 extending outwardly from a central region of an upper frame side element. Each of the light posts is thus positioned at a relatively short and defined distance from the periphery of a tower, for example a minimal distance between the light post and tower periphery of 30 cm, although this distance is generally reduced due to the presence of the growing leaves. While the tower rotates, the actual distance from a plant to the light post varies. The four bottom bars 197 extend inwardly from a bottom portion of each of the light posts underlying a corresponding corner of upper frame 191 and are connected together.

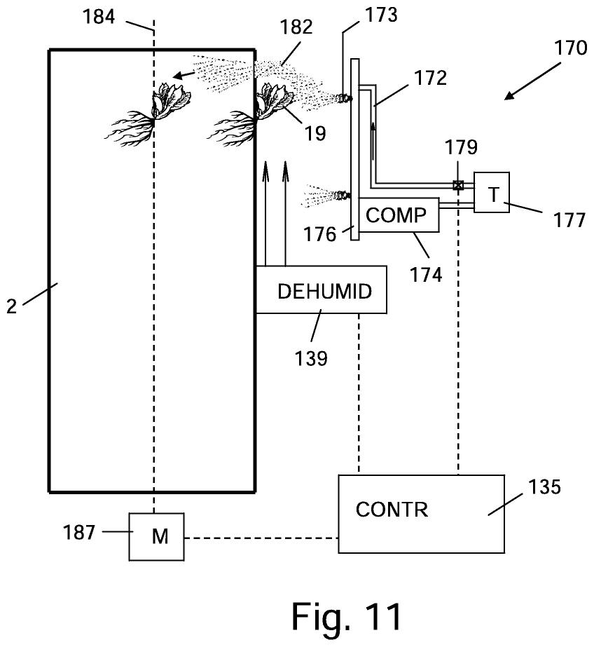

The central opening of upper frame 191 facilitates the positioning of ceiling fan 162 (FIG. 13), the purpose of which will be described hereinafter. Ceiling fan 162 may be suspended by a hangar attached to an overlying ceiling region, so as to be positioned within the central opening, whether at, above or below the height of upper frame 191. Alternatively, the grille 164 of fan 162 may be connected to two or more side elements 193 of upper frame 191.

Each tower 2a-d may be configured with one or more access hatches 199 that cover a corresponding opening formed in the periphery of a tower. The hatches 199 enable maintenance workers to access the hollow core of a tower, in order to clean or repair the tower periphery and the irrigation elements, for example, or for harvesting purposes. The hollow core also facilitates the growth of plants with large sized tubers and bulbs.

As shown in FIG. 13, each tower may be configured with a polygonal periphery that is substantially circular, such that each vertically extending and planar wall 192 defines a wall of the polygon. A plurality of vertically spaced planting holes 208 by which a plant is mounted on the tower are formed within each wall 192. If a plant has a size which is not compatible with the opening of a planting hole 208, a supporter 211 shown in FIG. 15, e.g. configured as an elbow made of molded rubber or plastic, may be removably inserted in one of the planting holes to assist in securely mounting a differently sized plant.

For example, a tower configured with a height of 240 cm and a diameter of 57 cm was formed with 11 planting holes 208 in each wall 192, when each planting hole was spaced by 20 cm center to center from an adjacent planting hole on the same wall.

Walls 192 may be made of an opaque or black material for optimal light absorption. The inner surface of a wall 192 may be provided with grooved drainage channels, e.g. vertically extending, by which irrigation fluid is directed towards the roots of the plants, to thereby maximize usage thereof.

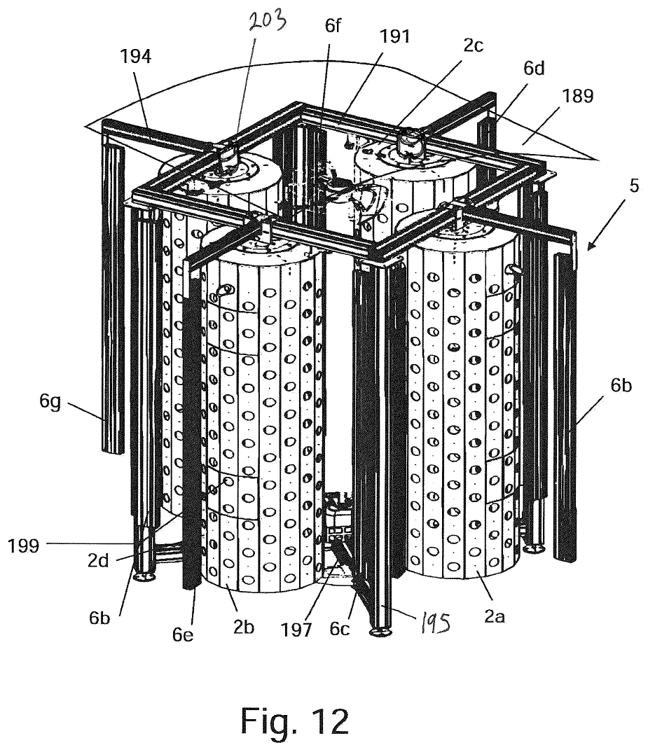

One embodiment of the drive unit is shown in FIGS. 13 and 14. A serrated wheel 196 is fixed to the upper surface 197 of each of the towers, so as to be coaxial therewith. The longitudinal axis of serrated wheel 196 is rotatably mounted at the corresponding junction 200 between upper frame side element 193 and cross member 194, to facilitate rotation of the tower.

A terminal end 201 of a substantially horizontally disposed reciprocating piston rod assembly 202, which may be hydraulically, pneumatically or electrically actuated, is connected, e.g. pivotally connected, to bracket 207 extending downwardly from side element 193. Piston rod assembly 202 has a bifurcated head 206 that is adapted to receive within its interior a tooth 198 radially extending from the periphery of serrated wheel 196, when the piston rod is extended, and to apply a force to a side edge of tooth 198, causing serrated wheel 196 and the tower connected thereto to rotate about its vertically oriented longitudinal axis for a discrete angle depending on the predetermined stroke of the piston rod. The piston rod is then retracted, in anticipation of an additional rotation initiating operation.

In order to ensure substantially homogeneous distribution of the light emitted by the elongated light posts onto vertically spaced plants, which may be spaced along a common tower by a large difference in height of as much as 3 meters or more, the light elements are densely mounted on each light post, for example 50 light elements are mounted within a distance of 50 cm such that only one light element is mounted at any given height. A number and sequence of light elements may be pinpointed in order to generate a plant-specific light signature that will optimize plant growth.

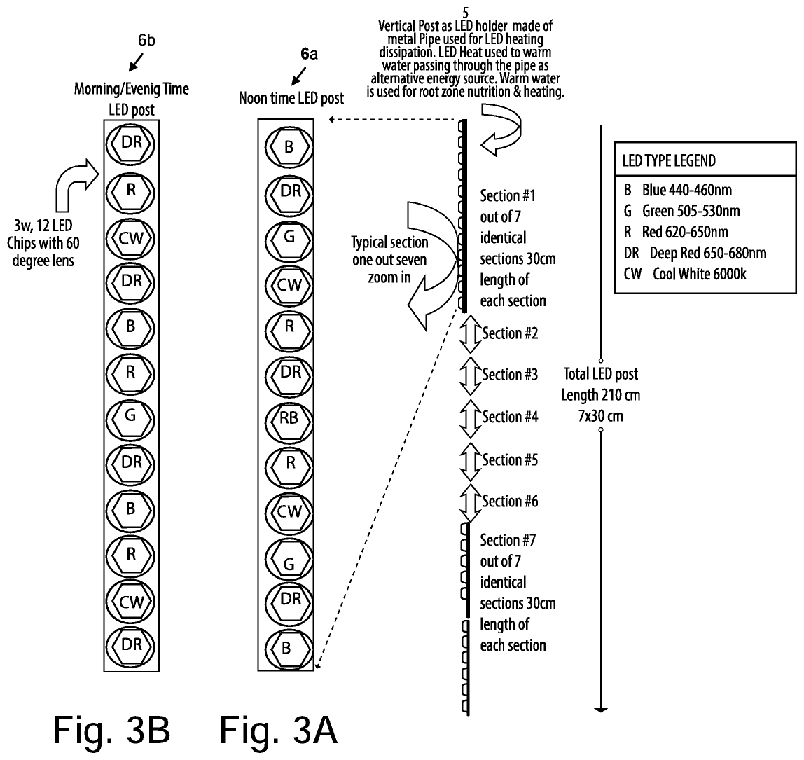

FIGS. 3A and 3B schematically illustrates an exemplary sequence of the light elements, which are shown in exaggerated size for clarity and are mounted on light posts 6a and 6b for generating an illumination signature that emulates the lighting conditions of noontime and of reduced light intensity conditions, respectively. The light elements, which are vertically spaced and vertically aligned, are preferably LED elements, although other light elements are also in the scope of the invention. Each light post is preferably tubular, to maximize heat dissipation from the continually operating light elements. If so desired, the light elements may be operated according to a selected duty cycle or time sequence, in order to generate a desired waveform.

Light elements for emitting the following five colors are illustrated: blue (B) at a wavelength of 440-460 nm for use mainly during noon conditions, green (G) at a wavelength of 505-530 nm, red (R) at a wavelength of 620-650 nm for use mainly during morning/afternoon conditions, deep red (DR) at a wavelength of 650-680 nm, and cool white (CW) at a color temperature, or the temperature of an ideal black-body radiator that radiates light of a comparable hue, of 5000° K. These colors were selected as they constitute the basic spectral components of sunlight needed by plants, although other colors are also in the scope of the invention.

The sequence of the light elements is carefully selected so as to generate a desired plant-specific light signature as a result of the interaction of the light beams emitted from adjacent light elements and of the vertical wavelength distribution throughout the length of the light post. The light signature generated by two adjacent light posts is also able to interact.

A segment 31 of light elements 33 having a height J is shown in FIG. 3C. Segment 31 includes a predetermined number of vertically spaced light elements 33, for example 30 elements. Each light element 33 of segment 31 emits a corresponding beam that impinges upon a peripheral portion 27 of tower 2, which is spaced by a distance K from light post 6. Within the conical distribution angle 36 of light that is emitted from segment 31, being bounded by equal sides L to define an isosceles triangle in cross section, the constituent beams emitted from each light element 33 are mixed to provide a photosynthetic photon flux density (PPFD) at peripheral portion 27 that optimally stimulates photosynthesis for the given plant being grown. Likewise the PPFD at any other peripheral portion 27, or at any leaf of the plant being cultivated which is adapted to absorb the emitted light, included within conical angle 36 is substantially equal. The light element sequence of segment 31 is repeated along the height of light post 6. for all other segments, for example segment 32 adjacent to segment 31. This light element arrangement thus promotes substantially equal light distribution to all plants being grown throughout the height of tower 2.

Morning and afternoon lighting conditions may be emulated, for example, by generating the following percentage of relative light energy corresponding to spectral components of light emitted from a light element segment: (1) dark blue at a wavelength of approximately 450 nm, 12%, (2) red at a wavelength of approximately 660 nm, 62%, (3) infrared at a wavelength of approximately 730 nm, 7%, and (4) white at a color temperature of 4000° K, 19%. Plants are generally exposed to these morning and afternoon lighting conditions for two quarters of a 24-hour period.

Noon lighting conditions may be emulated, for example, by generating the following percentage of relative light energy corresponding to spectral components of light emitted from a light element segment: (1) dark blue at a wavelength of approximately 450 nm, 34%, (2) red at a wavelength of approximately 660 nm, 31%, (3) infrared at a wavelength of approximately 730 nm, 7%, and (4) white at a color temperature of 4000° K, 28%. Plants are generally exposed to these noon lighting conditions for one quarter of a 24-hour period.

The tubular configuration of the light posts may also be utilized to enable circulation through their interior of an irrigation fluid. The irrigation fluid flowing through the sealed interior of a light post cools the continually operating light elements, and in turn becomes heated to plant growth inductive temperature of approximately 30° C. The heated irrigation fluid in turn is directed to the plants, for fostering their growth. The normally unexploited energy source of heat dissipated from light sources is therefore utilized to improve the plants' growth.

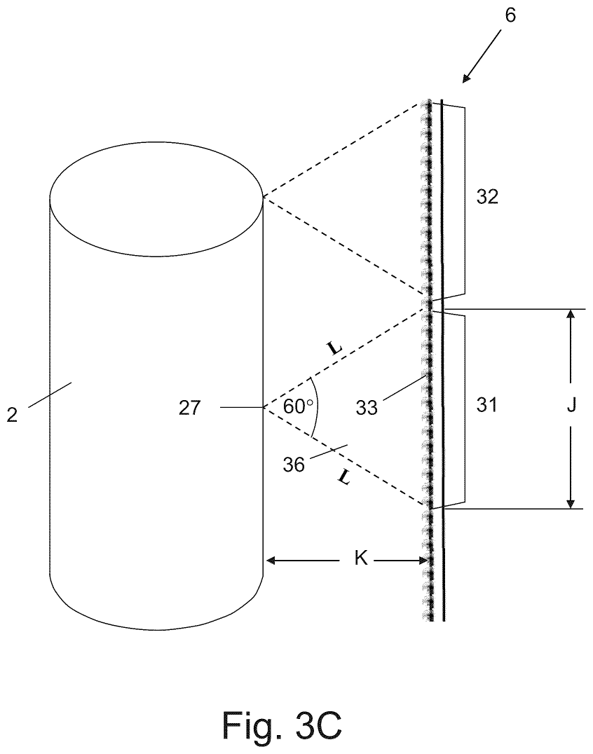

FIG. 4 illustrates one embodiment of irrigation means 30 for watering the plants which are being hydroponically cultivated. Cold irrigation fluid 34 is injected into the interior 37 of light post 6 and is progressively heated as it rises within the light post interior. The warm irrigation fluid 34 is discharged from the top of light post interior via emitter 39 to reservoir 46 located at the top of tower 2, for example at a rate of 1 L/min.

Each plant 19 being cultivated is retained in a basket 41 that allows the roots to be exposed to the irrigation fluid. Basket 41 is turn is mounted in a corresponding inclined hollow holder 45, e.g. cylindrical, which is secured to, or integrally formed with, the vertical outer wall 45 of tower 2, allowing each plant 19 to suitably grow while being exposed to the light emitted from elements 9.

A corresponding conduit 49 extends downwardly, for example at an incline, from reservoir 46 to a holder 43, or from a first holder to a second holder therebelow, to introduce the irrigation fluid to each holder. As each holder 43 is disposed at an incline with respect to vertical wall 45, the accumulation 52 of the introduced irrigation fluid is collected at the bottom of the holder at a height suitable for the immersion therein of the roots of plant 19 so as to supply nutrients to the plant, and then overflows in cascaded fashion to the holder therebelow. The spent overflow eventually flows to reservoir 54 at the bottom of tower 2. Each conduit 49 may be semicircular so as to simulate oxidation within the cascading irrigation fluid while being exposed to the surrounding air.

The effluent from bottom reservoir 54 flows through standpipe 56 to a secondary catchment tank 58 and then to main catchment tank 59 by gravity, to which fresh water is added via inlet 61. A blend tank 63 receives the discharge from main catchment tank 59. Additives, such as nitrogen, phosphorus, potassium, and other essential nutrients normally found in soil, are added, in optimum concentrations and in correct balance, are added. An aeration pump 67 delivers the produced irrigation fluid 34 to the inlet of the light post interior 37.

A sound emitter 51, e.g. a loudspeaker, may be mounted on the outer wall of light post 6, for generating acoustical signals that may be conducive for the plant growth.

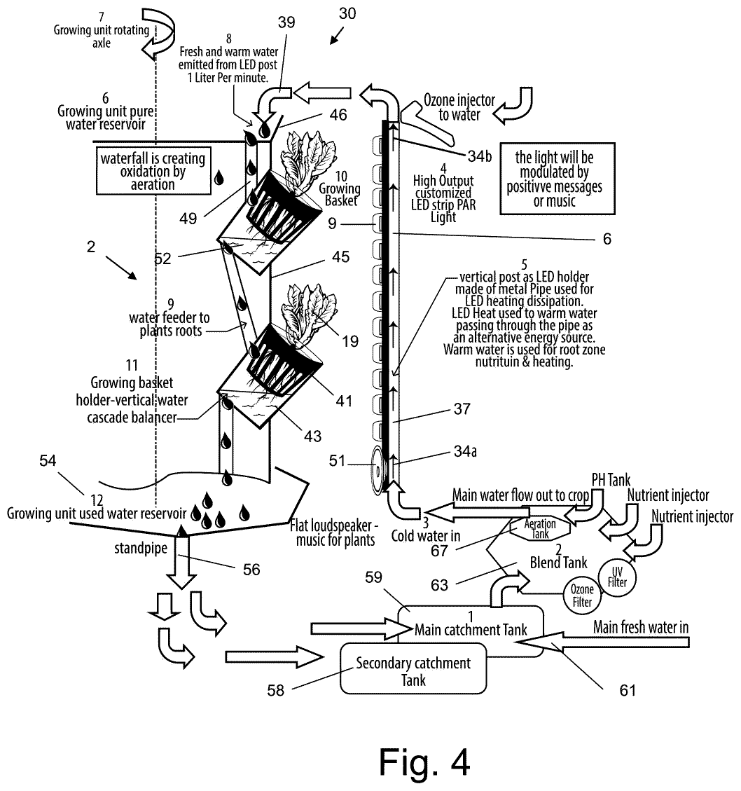

Irrigation means 70 illustrated in FIG. 5 may be used for watering plants 19 which are being aeroponically cultivated. Irrigation fluid is introduced from blend tank 63 to pipe 72 formed within the interior of vertical shaft 74 by which tower 2 rotates. The blending of the irrigation fluid is similar to that described in FIG. 4. A plurality of vertically spaced foggers 76 mounted on vertical shaft 74 and in fluid communication with pipe 72 eject a mist 79 directed to the roots 81 of plants 19 for providing a plentifully supply of oxygen. Each plant 19 being cultivated is retained in a basket 41 which is fitted within an aperture formed in vertical wall 45 of tower 2, and is mounted at an incline by means of a corresponding oblique brace 77, thereby allowing roots 81 to be exposed to the irrigation fluid.

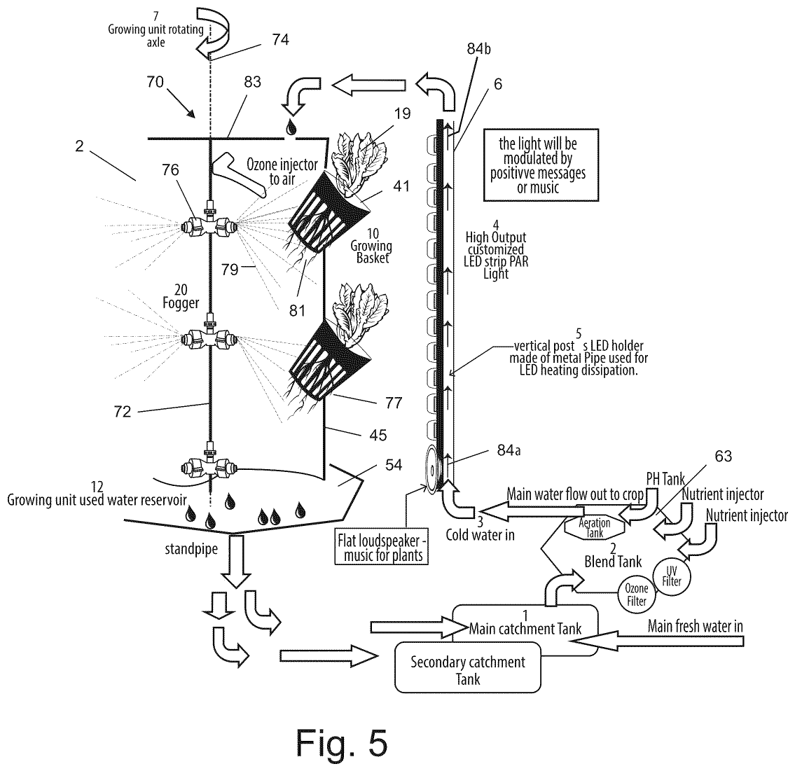

An exemplary arrangement of apertures 89 formed in outer tower wall 45 is shown in FIGS. 6A and 6B.

At the same time, rotation of shaft 74 according to a predetermined timing sequence causes plants 19 to be exposed to the light generated at any given time by one or more of light posts 6. The interior of each light post interior is cooled by injected cold water 84 that is progressively heated as it rises. The heated water 84 is discharged through top plate 83 of tower 2 and is collected at bottom reservoir 54.

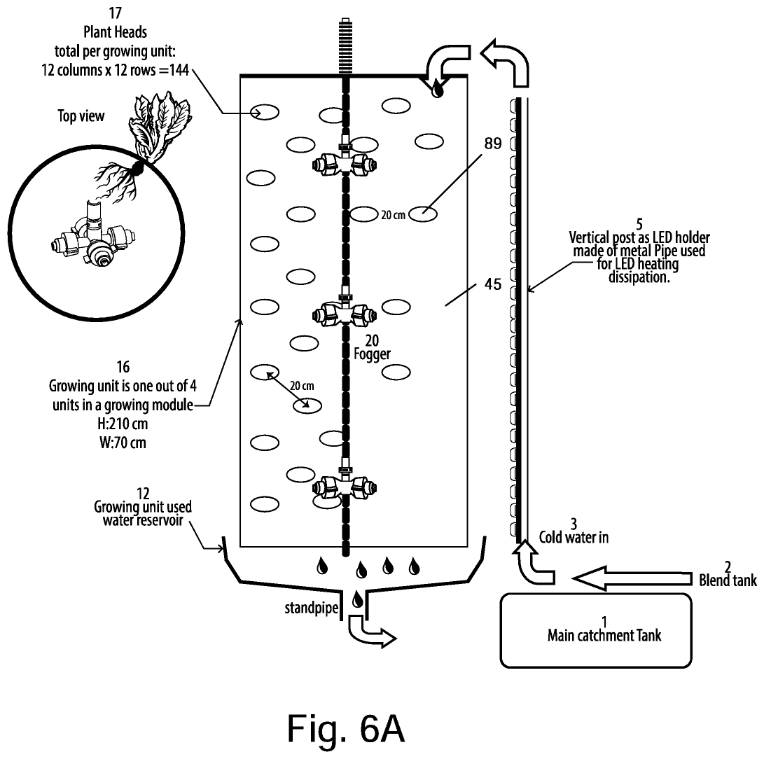

FIG. 7 illustrates a configuration of an outer wall 95 of the plant growth tower by which water conservation is considerably increased. Outer wall 95 is formed with a plurality of narrow slots 91, each of which is preferably recessed in order to receive liquid discharge from a fogger that has impacted the outer wall and would normally flow downwardly into the bottom reservoir of the tower without irrigating a plant. Each slot 91 extends for example from upper edge 92 of outer wall 95 to the periphery of an aperture 89 into which a plant growing basket is fitted, thereby providing another source of irrigation in addition to the fogger discharge. A slot 91 need not be straight as shown, but rather may be curved, or assume any other desired shape or disposition.

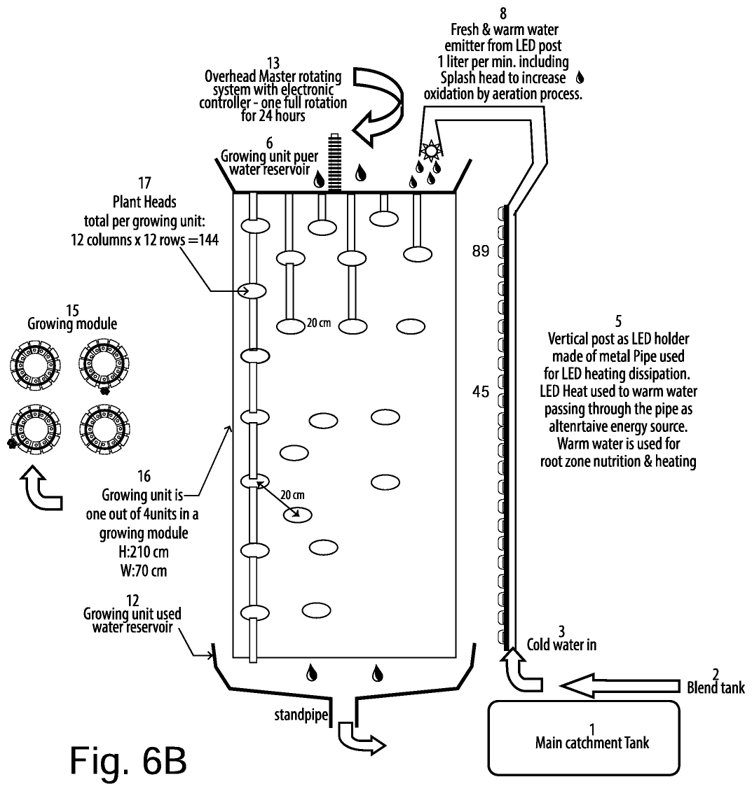

FIG. 8 schematically illustrates an open-loop recycling system 110 for efficiently utilizing the irrigation fluid. In system 110, the roots 81 of plants 19 retained within the interior of tower are aeroponically irrigated by means of the irrigation fluid that is delivered by high pressure feed pump 115 through central vertical pipe 72 of tower 2 and to vertically spaced foggers 76, to produce a mist environment.

The irrigation fluid is fed to feed pump 115 from second mixing chamber 121, into which is introduced the discharge of both first mixing chamber 117 and ozone generator 126, the latter serving to inject an oxidizing agent in the form of O2 or O3 into irrigation fluid for the purpose of disinfecting waterborne organisms and thereby enriching the fluid. In first mixing chamber 117 are mixed fresh water flowing through valve 106, e.g. a control valve, and the discharge of dosage pump 124, e.g. a peristaltic dosing pump, which delivers a predetermined amount of nutrients, such as nitrogen, phosphorus, potassium, and acid, needed by the type of crop being cultivated.

Controller 135 is in data communication with feed pump 115, dosage pump 124, and ozone generator 126, in order to regulate the conductivity and pH of the irrigation solution and to deliver it to foggers 76 at predetermined times. Ozone generator 126 is generally commanded to operate shortly before the activation of feed pump 115, to ensure suitable oxygenation of the irrigation fluid. Controller 135 may also be in data communication with air conditioning system 137 and local dehumidifier 139 for maintaining a predetermined air quality, including a desired degree of humidity, in the vicinity of each tower 2.

The surplus irrigation fluid not consumed by the plant roots 81 is collected in a reservoir 101 at the bottom of tower 2. A condensate pump, upon being commanded by controller 135 at a predetermined time, delivers the collected irrigation fluid via conduit 146 to used fluid storage tank 142, which also receives condensate delivered from dehumidifier 139 via conduit 147. A recirculation pump in data communication with controller 135 delivers the reused fluid to first mixing chamber 117 via conduit 148 and valve 138, which may be a control valve commanded by controller 135.

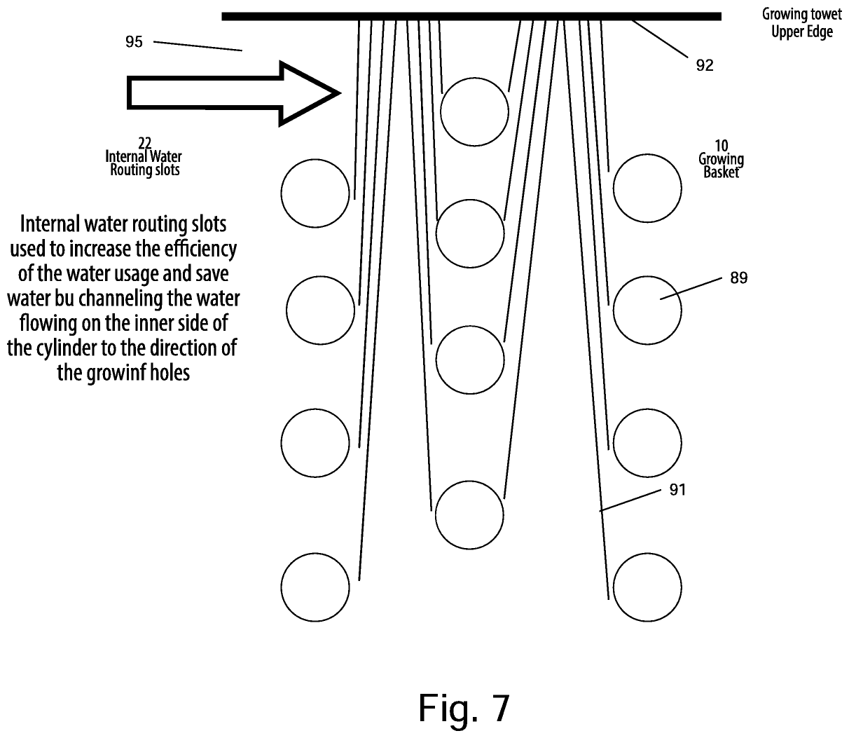

In addition to air conditioning system 137 and dehumidifier 139 (FIG. 8), the temperature of air in the vicinity of each tower may be controlled by means of the closed-loop liquid circulation system 155 shown in FIG. 9. Pump 151 delivers the cooling liquid upwardly through the interior of light post 6 to become progressively heated while the continually operating light elements mounted on the light post become cooled. The heated irrigation fluid discharged from the top of light post interior is pressurized by pump 153, and consequently flows at a sufficiently high rate through liquid-air heat exchanger, e.g. a radiator, to cause the surrounding air 159 to become heated. The heat depleted liquid is then introduced to pump 151. The increase in temperature of the surrounding air 159 may be controlled by the flowrate of the circulating liquid.

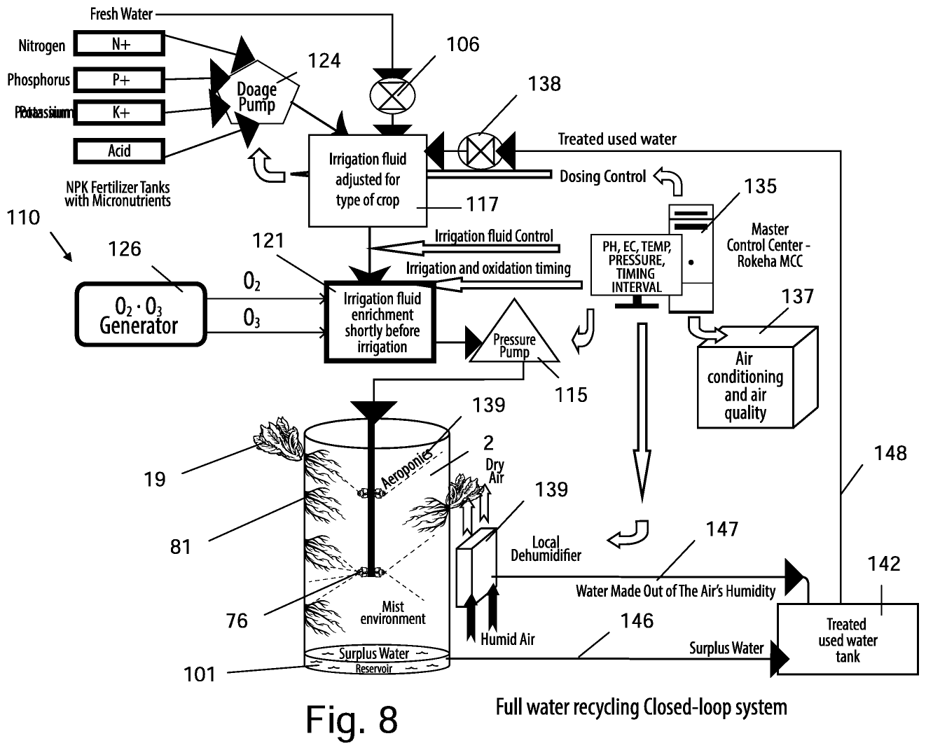

FIG. 10 illustrates an air circulation arrangement that facilitates an increase in plant growth. A ceiling fan 162 is installed so as to be centrally positioned within, and above, darkened interior region D of module 5. Since plants 19 release carbon dioxide during respiration at night, darkened interior region D is characterized by an increased concentration of carbon dioxide relative to other regions of the module. During operation of ceiling fan 162, the plant-released carbon dioxide, or air saturated with the plant-released carbon dioxide, is subjected to suction by ceiling fan 162, and is accordingly caused to be transported to outer noontime regions N of module 5, or alternatively to morning or afternoon regions. Plants 19 require a significant amount of carbon dioxide in order to conduct photosynthesis. By being able to direct the normally unexploited source of plant-released carbon dioxide to a daytime region, plants 19 are advantageously able to undergo an increased rate of growth while producing a larger amount of sugars and carbohydrates during the photosynthesis process as a result of absorbing a corresponding increased amount of carbon dioxide. Ceiling fan 162 may be deactivated when it overlies a region that is instantaneously illuminated with daytime light conditions.

The photosynthesis process is accompanied by loss of water as a result of evaporation from the stomates, or microscopic openings in the leaves of a plant through which incoming and outgoing gases such as carbon dioxide and oxygen and water vapor are released. The transport of plant-released carbon dioxide to a daytime region, resulting in a larger degree of photosynthesis, thus contributes to an even greater rate of water evaporation, inducing the plant in response to absorb a correspondingly increased amount of water through its roots to maintain an optimal water balance. The plant may also be induced to absorb an increased amount of water through its roots by commanding dehumidifier 139 (FIG. 8) to maintain a relatively low moisture level in the plant growing space surrounding a tower relative to the high moisture level within the core of a tower.

The intake of water through the roots of a plant is a major driving force for the movement of minerals from the roots and the transport of photosynthesis derived sugars throughout the plant. The plants grow in an optimal soilless environment at a controlled temperature and humidity, and consume a very small amount of water relative to their outdoor cultivated counterparts. As the roots do not have to expend the plant's energy to penetrate soil in quest for water and nutrients, the unused energy can be utilized by the plant's metabolic processes in other ways. For example, fruits tend to be sweeter, while leafy vegetables achieve a crispy leaf texture since the plant utilizes the unused energy to produce more minerals.

It will be appreciated that the plant-released carbon dioxide may also be transported through ducts, for example connected to upper frame 191 (FIG. 13), to a daytime region.

The temperature of the transported carbon dioxide, as well as fresh air, if desired to be mixed therewith, may be controlled by air conditioning system 137 as commanded by controller 135.

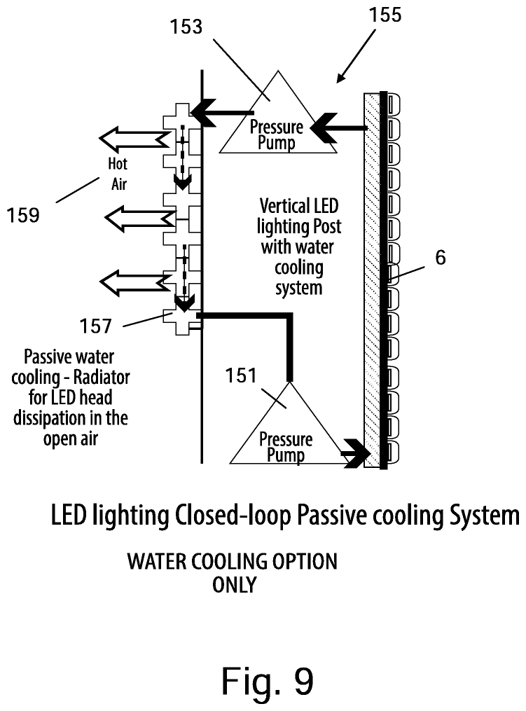

In another embodiment, the apparatus of the present invention may be used in conjunction with artificial pollination system 170 shown in FIG. 11.

Light post 176 carries a plurality of vertically spaced air discharge nozzles 173 which receive a pulsed supply of compressed air in parallel from air receiver tank 177. Air receiver tank 177 for storage of compressed air in turn is in fluid communication with compressor 174, positioned at a region of low humidity and possibly positioned on the floor of the facility. Compressor 174 is activated when the pressure within tank 177 is less than a predetermined low value, and is deactivated when the pressure within tank 177 is greater than a predetermined high value. A conduit 172 external to light post 176 extends from tank 177 and is in fluid communication with each nozzle 173, and a control valve 179 may be operatively connected with conduit 172, adjacent to the outlet port of tank 177. Each nozzle 173 may have a diverging outlet to direct the discharged compressed air in a conical pattern, to ensure impingement of the compressed air onto the stamen of plant 19, for example a strawberry plant, to induce the release of pollen 182 from its anther and the airborne transport of pollen 182 to the carpel of the same or of an adjacent plant.

Artificial pollination system 170 of course is capable of inducing the release of pollen from its anther only when the pollen bearing plant is reliably positioned in close proximity to a nozzle 173 at substantially the same height. Repeated and reliable rotational displacement of tower 2 about its longitudinal axis 184 may be made possible by a step motor 187, which is adapted to rotate tower 2 in discrete predetermined step increments in response to a command pulse received by the driver circuit. Alignment of a plant with a corresponding nozzle 173 may be achieved by knowing the angular displacement of each step, the diameter of the tower and the number of plants that are mounted around the circumference of the tower.

The efficacy of artificial pollination system 170 may be enhanced by a controlled change in the local humidity. Controller 135 is therefore operable to perform the five stage process of (1) commanding dehumidifier 139 to significantly reduce the local humidity in the vicinity of tower 2, for example to a level of 20% for strawberries, to reduce the adhesiveness of the pollen and to thereby support release of the pollen bearing anther from the stamen filament, (2) receiving information from the driver circuit of motor 187 as to when, or as to how many steps are made, until a given plant 19 will be positioned in pollen releasable proximity to nozzle 173, (3) commanding opening of control valve 179 for a predetermined time so that the compressed air will be directed to a given plant, (4) commanding dehumidifier 139 to significantly increase the local humidity in the vicinity of tower 2 following the anther release, for example to a level of 50% for strawberries, to ensure viability of the pollen and the adhesiveness of the stigma on which the pollen is to be deposited, and (5) closing control valve 179 at the conclusion of the pollination cycle.

The duration of the control valve opening may be regulated by controller 135 in response to the instantaneous air pressure within air receiver tank 177, to ensure a sufficiently high air flowrate to induce the release of pollen from its anther. For example, each nozzle 173 may be spaced 30 cm from the tower periphery, and the pressure of air when being discharged from the nozzle is about 6 bar, regardless of the number of nozzles.

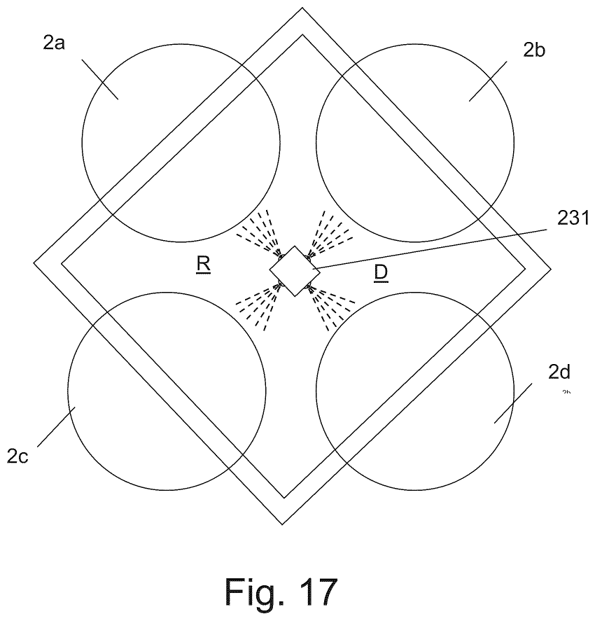

FIG. 18 illustrates another embodiment of the invention wherein the light emitted to the plants is modulated.

Several studies conducted by Dr. T. C. Singh, head of the Botany Department at Anamalia University, India and others confirmed that the music affects plant growth. Plants feel the vibration of the generated sound waves, and will speed the protoplasmic movement in the cells, to stimulate the manufacture of more nutrients that will give a stronger and better plant.

[http://hubpages.com/living/the-effect-of-music-on-plant-growth, updated on Nov. 12, 2015, Oct. 3, 2016]

Control system 240 directs modulated light energy to the plants to stimulate an improvement in metabolic processes similarly to a plant reaction to modulated acoustic waves. The modulated light energy is generated by a digital signal processing (DSP) module 245 configured with a suitable transfer function, which may be housed in controller 135 (FIG. 10) or in any other suitable hardware component. In response to the input of an audio file 241 transmitted by player 242, DSP module 245 transfers the audio signal to discrete frequency components, and then these frequency components are sequentially transferred to modulated voltage components and modulated light wavelength components to generate a corresponding light waveform. DSP module 245 also controls the light intensity of the light waveform, depending on the daylight region to which the plants are presently exposed, and filters the light waveform. The output light waveform is transmitted to the programmable power supply 247 of the LEDs 249 mounted on a light post to generate the desired modulated light beam 251.

In another embodiment, all planting holes formed in the tower walls are assigned a unique identifier which is stored in a system database. The following information related to each plant being grown is associated with the identifier and is also stored in the database: time of planting, growing protocol parameters, geographical location at any given time, and time of harvesting. The precise real-time geolocation of every plant with respect to a service passage facilitates the use of robotics for plant harvesting.

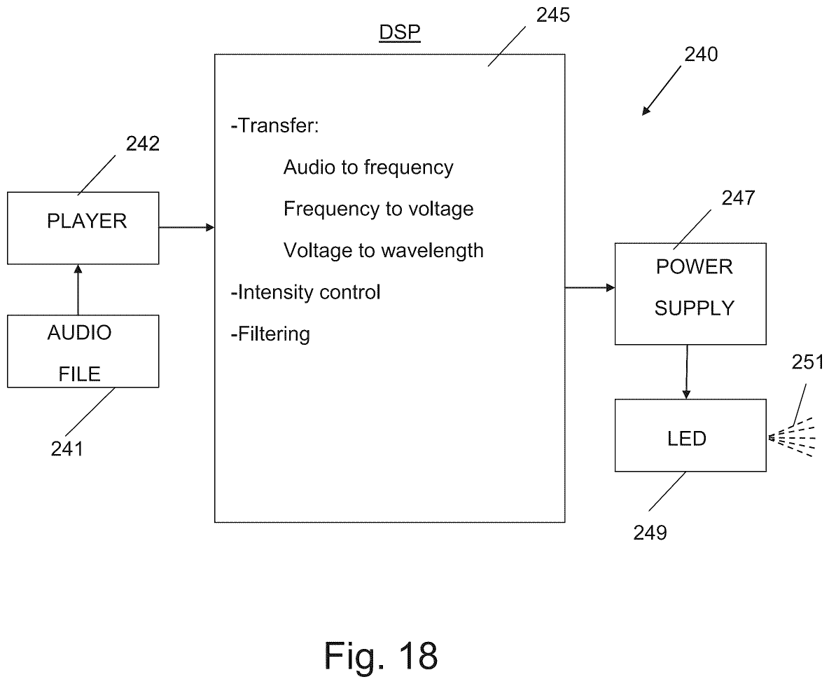

FIG. 19 illustrates another embodiment of a module 305 of a plant cultivation system. Module 305 includes four tubular rotatable towers 302a-d of annular cross section that are arranged in a symmetrical square-like configuration. The vertical shaft of each tower is rotatably mounted within an upper bearing housing 203 connected to the upper square frame 191 shown in FIG. 12 and to a lower bearing housing connected to a corresponding bottom bar 197 that extends horizontally from a support column 195 extending downwardly to the underlying ground or floor surface from a corresponding corner of frame 191 to a central region of convergence at which it is connected to the other bars 197. Each bottom bar 197 is raised above the underlying ground or floor surface. In this amendment, light posts 6a-h shown in FIG. 12 may be dispensed with. Alternatively, module 305 may be configured with any other suitable arrangement of structural elements.

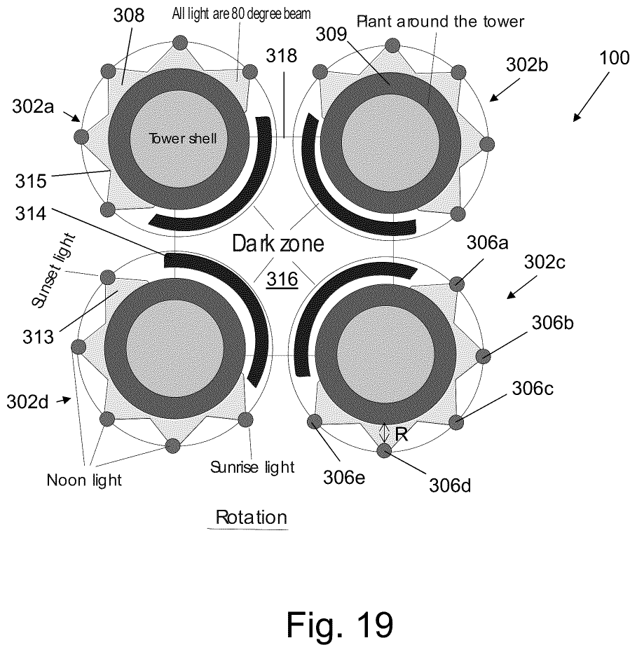

For each of the towers, five or any other suitable number of circumferentially spaced, stationary light posts 306a-e are positioned radially outwardly by a uniform radial distance R from the corresponding tower periphery 309, by the guide rods shown in FIG. 20 or by other suitable positioning means, to illuminate the plants being grown with a plant-specific and sector-specific light signature. The illustrated angular distance between the first light post 306a and the last light post 306e in the clockwise direction according to the illustrated orientation that defines an illuminated region 313, schematically illustrated as a shaded region between a light post and the tower periphery 309, is approximately 200 degrees, or any other suitable plant-specific limited angular distance. A circumferential non-illuminated region 314 between the last light post 306e and the first light post 306a in the clockwise direction according to the illustrated orientation is devoid of any light posts and essentially is not exposed to the light emitted by light posts 306a-e.

It will be appreciated that a module may likewise include three rotatable towers, suitably configured structural elements, and a plurality of circumferentially spaced light towers defining a limited angular distance.

The plant cultivation system associated with module 305 may be configured with one or more of the same features as described above, including for example an artificial pollination system, an airflow system by which plant-released carbon dioxide is transported to a daytime region, irrigation means and recycling system, air conditioner and dehumidification system and modulation means.

All vertically spaced light elements mounted on each of light posts 306a-e emit light at a constant intensity throughout a 24-hour period. A directional lens affixed to a corresponding light element which is preferably a diverging lens produces a predetermined diverging light emitting angle G, for example 80 degrees, with respect to a vertical and horizontal plane to suitably illuminate a peripheral region of the adjacent rotating tower by a beam 308 that is substantially aligned with all other beams generated by other light elements of the same light post. As a result of the predetermined light emitting angle G, two beams 308 each of which propagates from adjacent light towers converge at a convergence zone 315 positioned radially outwardly from the corresponding tower periphery 309 by a maximum radial distance significantly less than R, for example R/5.

Similar to module 5 of FIG. 1, each of towers 302a-d rotates about its longitudinal axis once every 24-hour period, allowing the plants being grown thereon to be cyclically exposed to the light emitted by the associated light posts. By carefully selecting the percentage and distribution of light elements on a light post, the plants being grown on a given tower are able to be sequentially exposed to morning light conditions, noon light conditions, afternoon light conditions and nighttime conditions to emulate natural growing conditions.

Although each of the light elements emit light at a constant intensity, the plants being grown are exposed to a varying light emission while a tower is being rotated even when exposed to noon light conditions. For example, a peripheral tower region separated from light post 306c by radial distance R is exposed to a light emission of approximately 600 PAR, and is exposed to a light emission of approximately 400 PAR when separated from the convergence zone between light posts 306c and 306d by radial distance R/5. Photosynthetic Active Radiation (PAR), measured by the amount of micro-moles of light per square meter per second, is an indication of light emission within the photosynthetic range of 400-700 nm used by plants for photosynthesis. The average value of the varying light emission is sufficient for optimal growth of the plants.

Alternatively, the plurality of light posts, for example three light posts 306b-d, positioned between first light post 306a and last light post 306e, help to provide the varying noon light conditions during the rotation of a tower. The varying noon light conditions may be a result of the change in light conditions resulting from the convergence of a beam having morning light conditions and a beam having noon light conditions.

As described above, the light elements, which are generally LED light elements, mounted on each of light posts 306a-e generally emit one of the five colors of blue, green, red, deep red, and cool white, which are the basic spectral components of sunlight needed by plants. The actual percentage of the light elements generating a specific color is selected to provide an optimal photosynthetic photon flux density for the given plant being grown insofar as the constituent beams emitted from each light element of a given light post are mixed, generally being a mix of white light, red light having an approximate wavelength of 630 nm and blue light having an approximate wavelength of 450 nm, and may vary for different light posts. For example, the predominant color emitted by the light elements of first light post 306a and last light post 306e is red to achieve a color temperature of 3800° K emulating sunrise and sunset hours of the day, while the predominant color emitted by the light elements of the other light posts of a given tower is blue to achieve a color temperature of 4500° K emulating noon light conditions.

The non-illuminated region 314 of each tower is adjacent to, and faces, the non-illuminated region of the other towers of module 305 by corresponding different directions to define a module darkened interior region, or dark zone 316, bounded by all non-illuminated regions of the module and by a narrow intervening interspace 318 between a pair of non-illuminated regions. Intervening interspace 318 has a width equal to at least the width of two light posts. As plants instantaneously facing a non-illuminated region 314 are substantially unexposed to the light emitted by light posts 306a-e, the ratio of light intensity at non-illuminated region 314 to the light intensity at an illuminated region 313 being no more than 1:30, they are able to receive a sensation of nighttime and release carbon dioxide during respiration since the photosynthesis process will be interrupted when the plants are exposed to such a low light intensity level.

The circumferential spacing between any two of light posts 306a-e of a tower 302 may be adjusted in conjunction with circumferentially extending upper guide rod 322 and lower guide rod 323 shown in FIG. 20. Each of light posts 306a-e on which are mounted a plurality of vertically spaced light elements 33 is configured with upper aperture 311 and lower aperture 312 through which upper guide rod 322 and lower guide rod 323 are inserted, respectively. Upper aperture 311 and lower aperture 312 are formed in a portion of a light post that is devoid of a light element and penetrate both side walls of the light post, being configured with same curvature as upper guide rod 322 and lower guide rod 323, respectively. By this arrangement, any of the light posts is able to be circumferentially displaced along guide rods 322 and 323 to a selected location in order to define a desired circumferential spacing CP between light posts or a desired angular distance of the illuminated region. Following the circumferential displacement, upper and lower locking members well known to those skilled in the art (not shown), such as pivotally displaceable or spring loaded locking members, are deployed to secure the light post to guide rods 322 and 323, respectively, to prevent additional circumferential displacement.

The illustrated guide rods 322 and 323 are shown to be circular hoops that are substantially concentric with tower periphery 309, and are fixed in position by means of a plurality of radial braces 327, e.g. four, extending from the non-illuminated region of the hoop to a same bearing housing 203. The radial distance R by which the hoops are spaced from tower periphery 309 is sufficiently less than the distance between the tower periphery and each support column 195 (FIG. 12) to prevent interference therewith. Each of circular guide rods 322 and 323 may be discontinuous and configured with a first end 329 that has a slightly larger diameter than the second end, allowing the second end to be received within, and secured by frictional or mechanical engagement to, the first end. A guide rod, which is flexible to a certain extent, is allowed to be introduced within an upper aperture 311 or lower aperture 312 when the first end is separated from the second end.

Upper guide rod 322 is positioned between upper edge 317 of tower periphery 309 and square frame 191 (FIG. 12). Lower guide rod 323 is positioned between lower edge 319 of tower periphery 309 and the plurality of bottom bars 197. A plurality of leg elements 326 extend downwardly to the underlying ground or floor surface from lower guide rod 323 by a sufficient length, e.g. 10 cm, to ensure that the lower guide rod will be positioned between lower edge 319 of tower periphery 309 and the plurality of bottom bars 197.

Alternatively, guide rods 322 and 323 may be arcuate with a predetermined angular length, having a radius of curvature that is substantially concentric with tower periphery 309. The average angular length of arcuate guide rods is 180 degrees to provide 12 hours of daylight and 12 hours of darkness. Two radial fixation braces 327 aligned with a non-illuminated region of the tower may extend from to a same bearing housing 203 to a corresponding circumferential end of the arcuate guide rod. The radial distance by which guide rods 322 and 323 are spaced from tower periphery 309 is sufficiently less than the distance between the tower periphery and each support column 195 (FIG. 12) extending below a corresponding corner of square frame 191 to prevent interference therewith. The light posts are able to be individually circumferentially displaced along the arcuate guide rods 322 and 323 to a selected location in order to define a desired circumferential spacing CP between light posts or a desired angular distance of the illuminated region.

An exemplary plant to be grown in tower 302 is a medicinal herb or a plant with cosmetic uses that is grown on the eastern slopes of a mountain during the winter months that have on the average 9 hours of sunlight. To accommodate the relative short daytime, the arcuate guide rods have an angular length of only 135 degrees and are operatively connected to four light posts. Since the plants are normally exposed to sunshine of relatively low intensity with the exception of noontime, some of the light posts emit light of relatively low intensity. Accordingly, the number of light elements mounted on the first light post is equal to one-half a nominal number of light elements and the predominant color emitted thereby is red. The number of light elements mounted on the second light post is equal to one-half the nominal number and the predominant color emitted thereby is blue. The number of light elements mounted on the third light post is equal to the nominal number and the predominant color emitted thereby is blue. The number of light elements mounted on the fourth light post is equal to one-half the nominal number and the predominant color emitted thereby is blue. As the plants being grown are naturally unexposed to the sunset hours due to the concealment caused by the mountain, a last light post emitting a red predominant color is unnecessary. In a controlled experiment, the yield of the plant grown in a module of towers 302 increased 30% relative to the yield of the same plant grown in an indoor greenhouse.

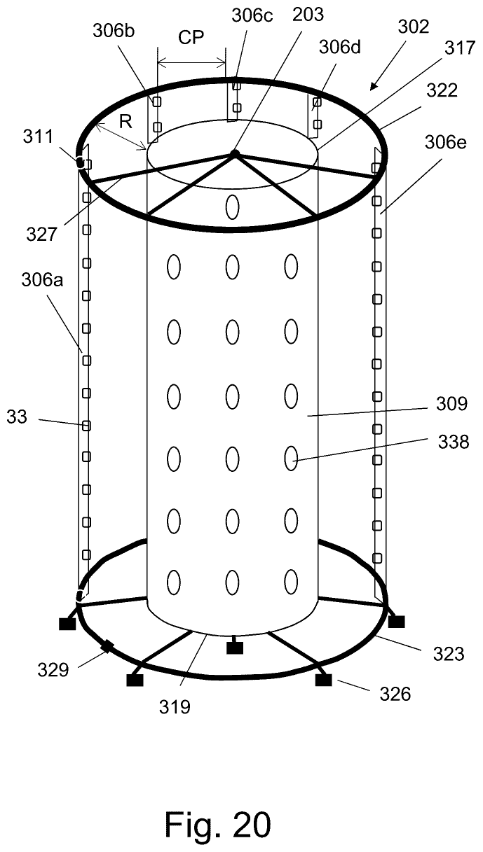

Also shown in FIG. 20 are a plurality of vertically and circumferentially spaced planting holes 338 formed within tower periphery 309. Each group of planting holes may be vertically aligned, or any other suitable arrangement for the planting holes may be provided. Each planting hole 338 constitutes a void region within which a plant growing basket 41 (FIG. 5) or receptacle 341 (FIG. 21) is able to be fitted.

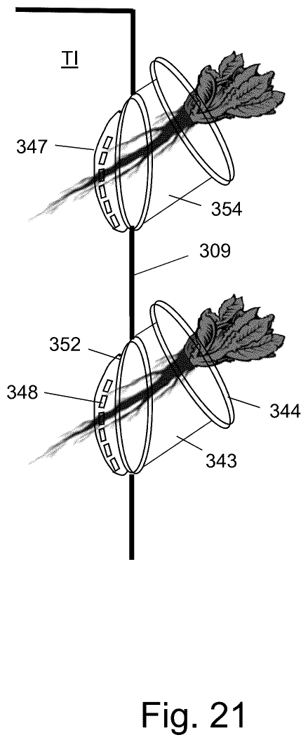

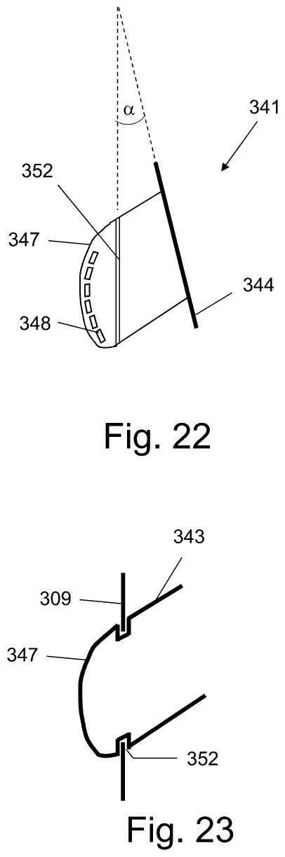

A plant growing receptacle 341 shown in FIGS. 21-23 is adapted not only to be releasably secured to tower periphery 309, but also to hold a dedicated sponge 354 for increasing the shelf life of a plant being cultivated. A sponge 354, for example made of polymeric material, has good water retaining characteristics and is adapted to transfer the retained moisture to the roots of the plant after the receptacle is removed from the tower. In addition to its good water retaining characteristics, sponge 354 is imparted with capillarity-inhibiting properties. The capillarity-inhibiting properties may be achieved when the sponge material is impermeable and relatively hydrophobic and the pores of the sponge are relatively large to receive within each pore a significant amount of water, although capillarity-inhibiting properties may be achieved in other ways as well.

By virtue of its capillarity-inhibiting properties, sponge 354 is assured of not becomes overly wet to prevent onset of root rot without having to control the surrounding temperature. Reducing moisture at the roots independently of temperature is of much importance since temperature control is needed to ensure that a given plant will be grown at its natural climate conditions.

Receptacle 341 is configured with an annular periphery 343 made of relatively thick elastic or resilient plastic material within which the plant being grown is held. Annular proximal end 344 has a larger diameter than periphery 343 to assist in manipulation of the receptacle. The distal end 347 of receptacle 341 insertable within the tower interior TI, which may be rounded, is formed with a plurality of apertures 348 by which the roots of the plant being grown are exposed to irrigation fluid and through which the roots are able to extend when increasing in size. A peripheral groove 352 for use in engaging receptacle 341 to tower periphery 309 is formed in periphery 343 proximate to apertures 348. While the diameter of receptacle periphery 343 is greater than the diameter of a planting hole, the resilient periphery is able to be momentarily compressed until its distal end 347 is inserted through the planting hole. Upon release of the compressing force, the receptacle periphery once again expands and a portion of the vertical tower periphery 309 is received in groove 352 to ensure secure engagement of receptacle 341.

Angle α between proximal end 344 and groove 352 may be selected to induce growth of the plant structure in a specific direction that is conducive for optimal growth of the plant being cultivated. A leafy vegetable such as lettuce may be set at a smaller angle α closer to the vertical plane than a fruit. This selected angle at which the plant extends outwardly from the plant periphery also assists in preventing interference with adjacent plants.

A sponge 354 is retained between proximal end 344 and distal end 347. As the plant continuously grows by virtue of the exposure to the irrigation fluid and to the light emitted by the light posts, the roots penetrate the porous sponge 354 and increasingly grow within the tower interior. When it is desired to market the plant, and particularly the fruits, herbs or vegetables grown thereby, receptacle 341 is simply detached from tower periphery 309 by a reverse process, and the roots are cut outwardly from the receptacle or at apertures 348 while severing the receptacle. Sponge 354 is removed from the receptacle together with the remaining plant structure. The plant is then marketed together with the sponge as the sponge prolongs the shelf life. The cut roots may be utilized for the extraction of oil.

The process of plant cultivation is made more efficient by employing receptacle 341 as the same receptacle can be used for both a germination stage and a cultivation stage.

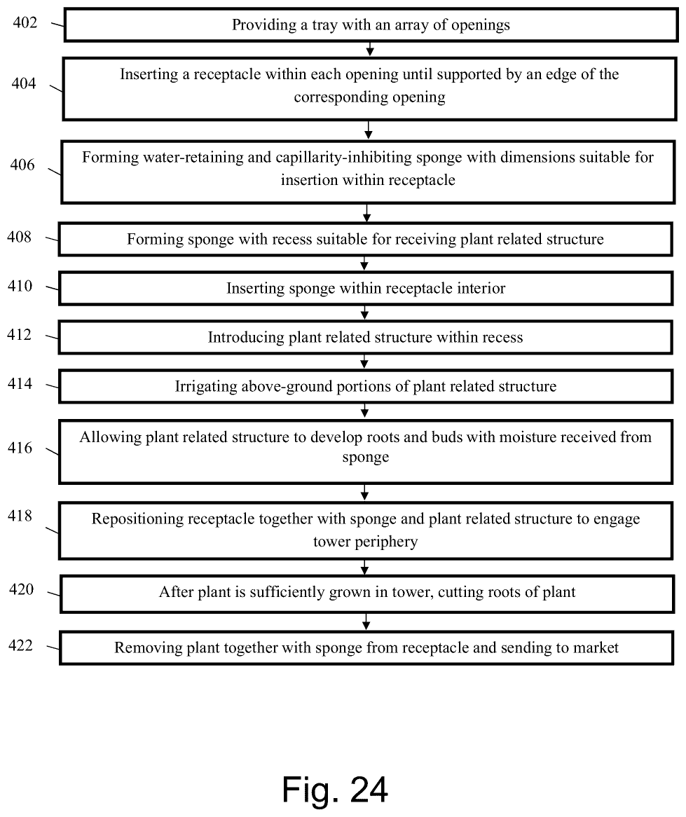

FIG. 24 illustrates a method for developing a bud aeroponically or hydroponically. Prior to the germination stage, a tray, for example a stainless steel tray, which is configured with an array of identical openings is provided in step 402. The previously described receptacle is inserted within each opening in step 404 until an edge of the opening supports a peripheral region of the corresponding receptacle, usually adjacent the distal end. A receptacle is generally manually inserted within each opening, but an automated insertion operation such as by means of a robot is also within the scope of the invention. A sponge piece made of the water-retaining and capillarity-inhibiting sponge is cut, removed or otherwise formed in step 406 to outer dimensions suitable for insertion within the receptacle interior and in step 408 with a recess suitable for receiving a plant related structure.

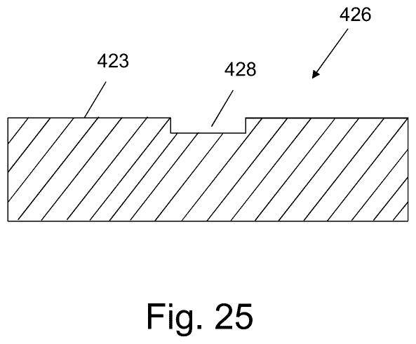

An exemplary sponge piece 426 having a thickness that is sufficient to fill each receptacle interior is shown in FIG. 25. Recess 428 is recessed from the upper edge 423 of a central region of the sponge piece and has a predefined depth, length and width that are suitable for retaining the plant related structure, such as a seed or a shoot. A single shallow recess 428 is formed in order to retain a seed. When a shoot that is larger than a seed is retained, the recess is deeper and may be cross-shaped or assume any other shape. Sponge piece 426 functions not only as mounting means within a receptacle, but also as means for transporting moisture to the plant related structure mounted thereby.

Returning back to FIG. 24, the sponge piece is inserted within the receptacle interior in step 410. The outer dimensions to which the sponge piece is cut are intended to exactly fit the dimensions of corresponding receptacles. Alternatively, the outer dimensions are cut to a diameter slightly greater than the diameter of the corresponding receptacle, so that when the sponge piece is forced to be downwardly displaced, it will be compressed and securely received by the peripheral wall of the corresponding receptacle. Then the selected plant related structure is suitably introduced within, and retained by, the recess in step 412.

During the germination stage, which is carried out until buds are developed in the retained plant related structure, irrigation intended to be directed to the above-ground portions, i.e. portions of the plant related structure that are normally located above-ground when the plant is grown in the ground, for example the epicotyl of a seed from which the entire shoot system develops, is provided aeroponically or hydroponically in step 414.

Effective germination is dependent upon a sufficiently high moisture content of approximately 25-50% and upon a reliable source of oxygen. A germinating seed is liable to rot if kept in a waterlogged state due to the lack of oxygen. The use of a water-retaining and capillarity-inhibiting sponge is well suited for the promotion of germination as the sponge constantly remains moist and transmits the moisture to the plant related structure. The sponge achieves a constant moisture level after absorbing the irrigation liquid, without absorbing an additional amount of irrigation liquid and becoming overly wet.

Once the seed germinates and the resulting seedlet or shoot develops roots and buds in conjunction with the moisture received from the sponge in step 416, the same receptacle carrying the sponge and plant related structure is repositioned and engaged with the periphery of a plant growth tower in step 418.

The roots grow in the direction of the irrigation liquid provided within the tower interior. After the plant sufficiently grows aeroponically, the roots are cut in step 420 and the plant together with the sponge piece is removed from the receptacle in step 422 and marketed.

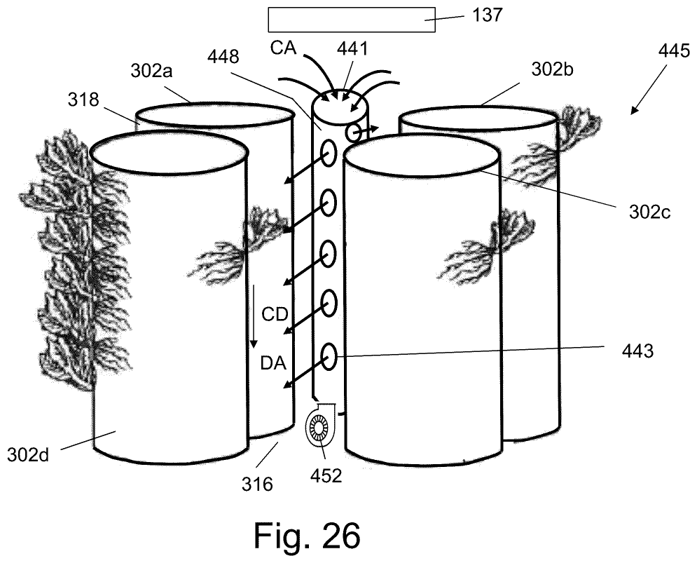

Another embodiment of an airflow system 445 for plant-released carbon dioxide is illustrated in FIG. 26 to facilitate an increase in plant growth. Airflow system 445 comprises a vertical air discharge tube 448 that is positioned in the central dark zone 316 (FIG. 12) of a given module. Tube 448 is configured with a plurality of vertically and circumferentially spaced discharge openings 443 formed within its periphery. A blower 452 is positioned within the interior of tube 448, adjacent to its closed bottom end. The upper inlet 441 of tube 448 is positioned in the vicinity of the discharge of conditioned air from air conditioner system 137.

During operation of air conditioner system 137 and blower 452, relatively cold conditioned air CA discharged from air conditioner system 137 is forced into tube 448 via inlet 441. The pressurized air DA generated by blower 452 is discharged through each discharge opening 443 into central dark zone 316 and cools the plants instantaneously exposed to the dark zone in emulation of night-time conditions. The pressurized discharged air DA combines with the carbon dioxide CD released from the plants during respiration to force the latter to flow through each intervening interspace 318 between each pair of adjacent towers 302a-d to a corresponding photosynthesis-suitable zone. Thus air saturated with the plant-released carbon dioxide, which has been warmed to a temperature greater than conditioned air CA, is caused to be transported to an illuminated region of the module for the benefit of the plants that require a significant amount of carbon dioxide in order to conduct photosynthesis.

It will be appreciated that airflow system 445 is also suitable to be implemented in conjunction with module 5 of FIG. 1, and may replace the airflow system illustrated in FIG. 10.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. Adaptive apparatus for use in conjunction with an indoor soilless plant cultivating system, comprising:
a) a plant growth tower configured with a drive unit that is rotatable about a substantially vertical axis by a complete tower rotation once every 24-hour period;
b) a plurality of stationary and circumferentially spaced light posts on each of which are mounted a plurality of vertically spaced light elements, light emitted by said plurality of light posts impinging on a periphery of said tower to define an illuminated peripheral region that is illuminated in accordance with a predetermined plant-specific illumination signature and a non-illuminated region associated with said tower periphery that is unimpinged by said emitted light;
c) one or more stationary guiding rods connected to a housing element of said tower, to which said plurality of light posts are mounted and by which a circumferential spacing between two of said light posts is adjustable; and
d) irrigation means for supplying the plants being cultivated in said tower with a nutrient-rich solution,
wherein said tower is rotatable about the substantially vertical axis so as to be sequentially exposed to morning light conditions, noon light conditions, afternoon light conditions and nighttime conditions.

2. The apparatus according to claim 1, wherein the tower is configured with a plurality of mounting elements by each of which a corresponding plant is mountable at a different tower peripheral portion and is urged to grow outwardly from said peripheral portion, groups of said mounting elements being defined at different height levels of the tower.

3. The apparatus according to claim 2, wherein leaves of all of the plants being grown on one of the towers are exposed to a substantially uniform distribution of light emitted from light elements mounted on an adjacent one of the light posts for a given emulated time period despite a height differential between the plants.

4. The apparatus according to claim 3, wherein the light elements are sufficiently small such that they have a density of no less than 40 light elements within a light post height of 50 cm and are mounted on each of the light posts in such a way that only one light element is mounted at any given height.

5. The apparatus according to claim 4, wherein a segment of the light elements has a predetermined number and sequence of light elements arranged such that constituent beams emitted from the light elements of said segment are mixed within a conical distribution angle to provide a photosynthetic photon flux density at the tower peripheral portion upon which the mixed beam impinges that stimulates photosynthesis for a given plant being grown.

6. The apparatus according to claim 5, wherein the photosynthetic photon flux density at another tower peripheral portion being illuminated at the given emulated time period is substantially equal.

7. The apparatus according to claim 5, wherein the predetermined number and sequence of light elements are repeated along the height of the light post for all other segments.

8. The apparatus according to claim 1, further comprising a dosage pump for delivering a predetermined amount of nutrients needed by the type of plant being cultivated, and a controller in data communication with said dosage pump which is operable to regulate conductivity and pH of the irrigation solution deliverable to the irrigation means at predetermined times.

9. The apparatus according to claim 1, which is mounted in an indoor facility that is isolated from outdoor conditions present outwardly from the facility.

10. The apparatus according to claim 9, further comprising an artificial pollination system for facilitating production of fruit and seed crops within the indoor facility.

11. The apparatus according to claim 10, wherein the artificial pollination system comprises a plurality of vertically spaced air discharge nozzles carried by each of the light posts, a pulsed supply of compressed air received in parallel by said nozzles from an air receiver tank serving to induce release of pollen from an anther of plants being instantaneously positioned in proximity of said nozzles.

12. The apparatus according to claim 11, wherein the artificial pollination system further comprises a conduit external to the light post which extends from the air tank and is in fluid communication with each of the nozzles, and a control valve operatively connected with said conduit and in data communication with the controller by which pressure of the compressed air is regulated.

13. The apparatus according to claim 12, wherein the artificial pollination system further comprises a unit for controlling local air humidity in the vicinity of each tower of the module, the controller being operable to:
a) command said unit to significantly reduce the local humidity to a level that ensures sufficient reduction in adhesiveness of the pollen for supporting pollen release;
b) receive information from a data source associated with the drive unit as to when a given plant will be positioned in pollen releasable proximity to the nozzle;
c) command opening of the control valve for a predetermined time so that the compressed air will be directed to said given plant;
d) command said unit to significantly increase the local humidity following the pollen release to ensure pollen viability; and
e) close the control valve at the conclusion of a pollination cycle.

14. The apparatus according to claim 13, wherein the unit is an air conditioner and a dehumidifier.

15. The apparatus according to claim 1, further comprising means for transporting plant-released carbon dioxide from a dark zone to a photosynthesis-suitable zone of the tower, to induce an increased rate of plant growth as a result of absorbing a corresponding increased amount of carbon dioxide.

16. The apparatus according to claim 1, further comprising an open-loop recycling system for reusing surplus irrigation fluid not consumed by plant roots.

17. The apparatus according to claim 1, wherein the light elements mounted on each of the light posts are in continual operation and are cooled by means of a cooling liquid introduced through a light post interior.

18. The apparatus according to claim 17, wherein the cooling liquid is the irrigation fluid.

19. The apparatus according to claim 1, wherein the light elements mounted on each of the light posts are modulated to stimulate an improvement in plant metabolic processes.
